(19) United States
(12) Patent Application Publication
(10) Pub. No.: US 2026/0003114 A1
(43) Pub. Date: Jan. 1, 2026

(54) LIQUID CRYSTAL POLARIZATION INTERFERENCE ELEMENT, OPTICAL FILTER, AND OPTICAL SYSTEM

(71) Applicant: FUJIFILM Corporation, Tokyo (JP)

(72) Inventors: Yukito SAITOH, Minamiashigara-shi (JP); Yujiro YANAI, Minamiashigara-shi (JP); Kazuya HISANAGA, Minamiashigara-shi (JP)

(73) Assignee: FUJIFILM Corporation, Tokyo (JP)

(21) Appl. No.: 19/319,753

(22) Filed: Sep. 5, 2025

Related U.S. Application Data
(63) Continuation of application No. PCT/JP2024/008734, filed on Mar. 7, 2024.

(30) Foreign Application Priority Data
Mar. 8, 2023 (JP) 2023-035763
Jan. 26, 2024 (JP) 2024-010200

(51) Int. Cl. G02B 5/30

(52) U.S. Cl. CPC G02B 5/3016

(57) ABSTRACT

A liquid crystal polarization interference element is provided that suppresses fluctuation in the wavelength at which maximum transmittance occurs, even when light is incident at an oblique angle. The element includes two or more sets of liquid crystal layers, each set having a first liquid crystal layer and a second liquid crystal layer. Each of the first and second liquid crystal layers includes a liquid crystal layer R formed by immobilizing horizontally aligned rod-like liquid crystal compounds and a liquid crystal layer D formed by immobilizing vertically aligned disk-like liquid crystal compounds. The liquid crystal layer R and the liquid crystal layer D have parallel slow axes and equal in-plane retardations, and the first liquid crystal layer and the second liquid crystal layer have in-plane slow axes that intersect each other. An optical filter including the liquid crystal polarization interference element is also provided.

### CROSS-REFERENCE TO RELATED APPLICATIONS

This application is a Continuation of PCT International Application No. PCT/JP2024/008734 filed on Mar. 7, 2024, which claims priority under 35 U.S.C. § 119(a) to Japanese Patent Application No. 2023-035763 filed on Mar. 8, 2023 and Japanese Patent Application No. 2024-010200 filed on Jan. 26, 2024. The above applications are hereby expressly incorporated by reference, in their entirety, into the present application.

### BACKGROUND OF THE INVENTION

### 1. Field of the Invention

The present invention relates to a liquid crystal polarization interference element, an optical filter using the liquid crystal polarization interference element, and an optical system using the optical filter.

### 2. Description of the Related Art

A band-pass filter that transmits light in a specific wavelength range and shields light in other wavelength ranges is used in various optical devices.

As the band-pass filter, a polarization interference filter using a dielectric multi-layer film, a filter in which a polarizer and a birefringent crystal are combined, and the like are known.

In addition, a band-pass filter is also known, in which a Solc filter (folded Sole filter) is arranged between polarizers arranged in a crossed nicols state, the Sole filter being formed by alternately laminating a birefringent plate (λ/2 retardation plate) in which an angle formed between a direction of a transmission axis of a polarizer and a slow axis is +ρ, and a birefringent plate in which the angle is −ρ, both of which have the same thickness, between polarizers arranged in a crossed nicols state, as described in JP2004-101577A.

Furthermore, JP2004-101577A proposes, as an optical filter (Solc filter) capable of realizing a band-pass filter having a small number of components, an optical filter having a structure where two types of polarization regions having different crystals are periodically arranged, in which the principal axis of a refractive index ellipsoid cut parallel to an interface between the two different types of polarization regions differs between the two different types of polarization regions.

### SUMMARY OF THE INVENTION

However, the band-pass filter in the related art as described in JP2004-101577A has a problem in that there occurs a fluctuation in wavelength of light at which the maximum transmittance is exhibited upon incidence of light from an oblique direction, that is, a so-called wavelength shift.

An object of the present invention is to solve such a problem in the related art, and to provide, for example, a liquid crystal polarization interference element capable of suppressing a fluctuation in wavelength of light at which the maximum transmittance is exhibited upon incidence of light from an oblique direction, that is, a wavelength shift in a case where the liquid crystal polarization interference element is used in a band-pass filter; an optical filter including the liquid crystal polarization interference element; and an optical system using the optical filter.

In order to accomplish the object, the present invention has the following configurations.

[1] A liquid crystal polarization interference element including:
two or more liquid crystal layer sets in a thickness direction, each set consisting of a first liquid crystal layer and a second liquid crystal layer,
in which the first liquid crystal layer includes at least one liquid crystal layer R1 formed by immobilizing horizontally aligned rod-like liquid crystal compounds, and at least one liquid crystal layer D1 formed by immobilizing vertically aligned disk-like liquid crystal compounds,
the second liquid crystal layer includes at least one liquid crystal layer R2 formed by immobilizing horizontally aligned rod-like liquid crystal compounds, and at least one liquid crystal layer D2 formed by immobilizing vertically aligned disk-like liquid crystal compounds,
an in-plane slow axis of the liquid crystal layer R1 and an in-plane slow axis of the liquid crystal layer D1 are parallel to each other,
an in-plane slow axis of the liquid crystal layer R2 and an in-plane slow axis of the liquid crystal layer D2 are parallel to each other,
the in-plane slow axis of the liquid crystal layer R1 and the in-plane slow axis of the liquid crystal layer R2 intersect with each other,
a sum of in-plane retardations of the liquid crystal layers R1 and a sum of in-plane retardations of the liquid crystal layers D1 are equal to each other, and
a sum of in-plane retardations of the liquid crystal layers R2 and a sum of in-plane retardations of the liquid crystal layers D2 are equal to each other.

[2] The liquid crystal polarization interference element according to [1],
in which an in-plane retardation of the first liquid crystal layer and an in-plane retardation of the second liquid crystal layer are equal to each other.

[3] The liquid crystal polarization interference element according to [1] or [2],
in which the in-plane slow axes of all of the liquid crystal layers R1 are parallel to each other and the in-plane slow axes of all of the liquid crystal layers R2 are parallel to each other, and
the in-plane retardations of all of the first liquid crystal layers are equal to each other and the in-plane retardations of all of the second liquid crystal layers are equal to each other.

[4] The liquid crystal polarization interference element according to any one of [1] to [3]
in which an in-plane slow axis direction of the liquid crystal layer R1 of the first liquid crystal layer and an in-plane slow axis direction of the liquid crystal layer R2 of the second liquid crystal layer in the liquid crystal layer sets arranged on both sides in the thickness direction and the liquid crystal layer set arranged in a central part in the thickness direction are different from each other, and
in-plane retardations of the first liquid crystal layer in the liquid crystal layer sets arranged on both sides in the thickness direction and the liquid crystal layer set arranged in the central part in the thickness direction are different from each other.

[5] The liquid crystal polarization interference element according to any one of [1] to [4],
in which the liquid crystal layer R1 and the liquid crystal layer D1 of the first liquid crystal layer and the liquid crystal layer R2 and the liquid crystal layer D2 of the second liquid crystal layer include an infrared absorbing colorant.

[6] The liquid crystal polarization interference element according to any one of [1] to [5],
in which the liquid crystal layer R1 and the liquid crystal layer D1 of the first liquid crystal layer and the liquid crystal layer R2 and the liquid crystal layer D2 of the second liquid crystal layer include a liquid crystal elastomer.

[7] A liquid crystal polarization interference element including:
two or more liquid crystal layer sets in a thickness direction, each set consisting of a first liquid crystal layer and a second liquid crystal layer,
in which the first liquid crystal layer or the second liquid crystal layer includes at least one liquid crystal layer R including a rod-like liquid crystal compound,
the first liquid crystal layer or the second liquid crystal layer includes at least one liquid crystal layer D including a disk-like liquid crystal compound,
an in-plane slow axis of the first liquid crystal layer and an in-plane slow axis of the second liquid crystal layer intersect with each other, and
a sum of in-plane retardations of the first liquid crystal layers and a sum of in-plane retardations of the second liquid crystal layers are equal to each other.

[8] The liquid crystal polarization interference element according to [7],
in which the liquid crystal layer R and the liquid crystal layer D include an infrared absorbing colorant.

[9] The liquid crystal polarization interference element according to [7] or [8],
in which the liquid crystal layer R and the liquid crystal layer D include a liquid crystal elastomer.

[10] An optical filter including, arranged in the following order:
a first polarizer;
the liquid crystal polarization interference element according to any one of [1] to [9]; and
a second polarizer.

[11] The optical filter according to [10],
in which the first polarizer and the second polarizer are provided to sandwich the liquid crystal polarization interference element in a thickness direction.

[12] The optical filter according to or [11],
in which the first polarizer and the second polarizer are arranged such that transmission axes of the two polarizers are orthogonal to each other.

[13] The optical filter according to or [11],
in which the first polarizer and the second polarizer are arranged such that transmission axes of the two polarizers are parallel to each other.

[14] The optical filter according to any one of to [13], further including:
a retardation layer between at least one of the first polarizer or the second polarizer, and the liquid crystal polarization interference element,
in which an in-plane slow axis of the retardation layer and an absorption axis of any of the first polarizer and the second polarizer are parallel to each other.

[15] An optical system including:
a light source unit;
the optical filter according to any one of [10] to [14]; and
a light receiving section.

[16] The optical system according to [15], further including:
a condenser lens.

[17] The optical system according to [15] or [16], further including:
a beam splitter.

[18] The optical system according to any one of [15] to [17], further including:
a light guide element.

[19] The optical system according to any one of [15] to [18],
in which the optical filter and the light receiving section are adjacent to each other.

[20] The optical system according to [19], further including:
a plurality of the optical filters having different central wavelengths of transmitted light.

According to the present invention, it is possible to suppress a fluctuation in wavelength of light at which the maximum transmittance is exhibited upon incidence of light from an oblique direction, that is, a wavelength shift, for example, in the band-pass filter.

### BRIEF DESCRIPTION OF THE DRAWINGS

FIG. 1 is a view conceptually showing an example of an optical filter of an embodiment of the present invention, the optical filter using a liquid crystal polarization interference element of an embodiment of the present invention.

FIG. 2 is a graph for describing the optical filter of the embodiment of the present invention.

FIG. 3 is a graph for describing the optical filter of the embodiment of the present invention.

FIG. 4 is a conceptual view showing another example of the liquid crystal polarization interference element of the embodiment of the present invention.

FIG. 5 is a conceptual view showing another example of the liquid crystal polarization interference element of the embodiment of the present invention.

FIG. 6 is a conceptual view showing another example of the liquid crystal polarization interference element of the embodiment of the present invention.

FIG. 7 is a view conceptually showing an example of an optical system of an embodiment of the present invention.

FIG. 8 is a view conceptually showing another example of the optical system of the embodiment of the present invention.

FIG. 9 is a view conceptually showing another example of the optical system of the embodiment of the present invention.

FIG. 10 is a view conceptually showing another example of the optical system of the embodiment of the present invention.

FIG. 11 is a view conceptually showing another example of the optical system of the embodiment of the present invention.

### DESCRIPTION OF THE PREFERRED EMBODIMENTS

Hereinafter, a liquid crystal polarization interference element, an optical filter, and an optical system of embodiments of the present invention will be described in detail based on suitable Examples shown in the accompanying drawings.

In the present specification, numerical ranges represented by “to” include numerical values before and after “to” as lower limit values and upper limit values.

In addition, all of the drawings shown below are conceptual views for describing the present invention, and the positional relationship, size, thickness, shape, and the like of each constituent element are different from the actual ones.

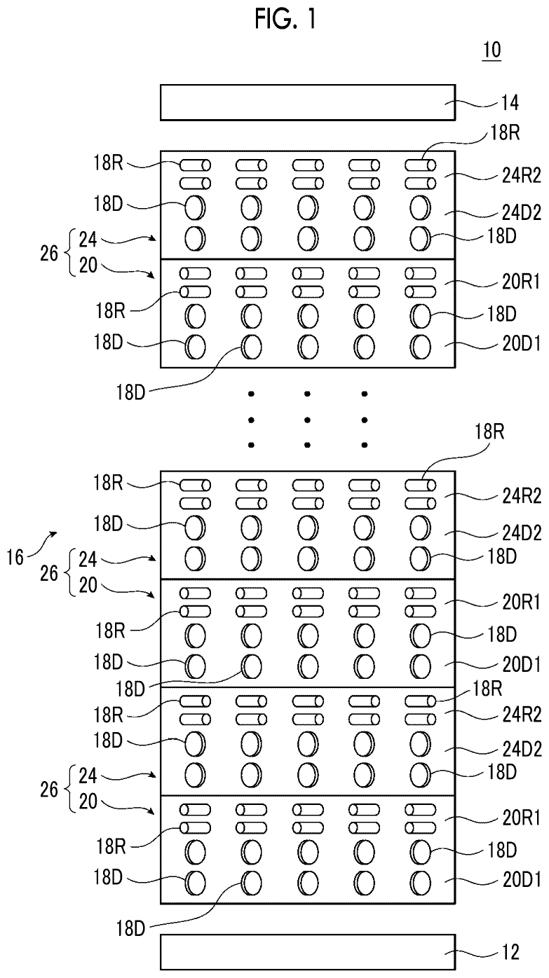

FIG. 1 conceptually shows an example of the optical filter of the embodiment of the present invention. Furthermore, in the following description, the optical filter will also be simply referred to as a filter.

The optical filter of the embodiment of the present invention is an optical filter in which a first polarizer, the liquid crystal polarization interference element of the embodiment of the present invention, and a second polarizer are arranged in this order.

A filter 10 shown in FIG. 1 is a band-pass filter (narrow-band filter) that transmits light in a specific wavelength range and shields light in other wavelength ranges, and has a first polarizer 12, a second polarizer 14, and a liquid crystal polarization interference element 16.

The liquid crystal polarization interference element 16 is a liquid crystal polarization interference element of a first aspect of the present invention, and is arranged between the first polarizer 12 and the second polarizer 14.

The first polarizer 12 and the second polarizer 14 are polarizers (polarizing plates) that transmit linearly polarized light in a predetermined direction, and are arranged in a crossed nicols state with transmission axes thereof being orthogonal to each other.

The first polarizer 12 and the second polarizer 14 are not limited and various known linear polarizers such as an iodine-based polarizer, a dye-based polarizer using a dichroic dye, a polyene-based polarizer, and a wire grid polarizer can be used.

In the filter 10 in the example shown in the drawing, the liquid crystal polarization interference element 16 is arranged between the first polarizer 12 and the second polarizer 14.

Furthermore, the first polarizer 12 and the second polarizer 14 are spaced from the liquid crystal polarization interference element 16 in FIG. 1.

However, the present invention is not limited thereto, and the first polarizer 12, the second polarizer 14, and the liquid crystal polarization interference element 16 may be laminated in contact with each other. In addition, in a case where the first polarizer 12 and the second polarizer 14 are in contact with the liquid crystal polarization interference element 16, they may be adhered to each other with an adhesive which is transparent to transmitted light, such as an optical clear adhesive (OCA) and an acrylic pressure sensitive adhesive, as necessary.

Furthermore, in the filter (optical filter) of the embodiment of the present invention, the polarizer is not limited to the above-described forms and various polarizers can be used as long as the function of light to polarized light in one direction is not limited.

For example, in a case where an optical element such as a light source (light source unit) and a light-receiving element (light receiving section) combined with the optical filter of the embodiment of the present invention has a polarizer, in a form in which the original polarized light is emitted from the light source combined with the optical filter of the embodiment of the present invention; a form in which the light-receiving element (light receiving section) combined with the optical filter of the embodiment of the present invention has polarization sensitivity characteristics in one direction; and the like, the polarizer included in the optical element, and the light source and the light receiver are also regarded as the polarizer constituting the optical filter of the embodiment of the present invention. Furthermore, examples of the form in which the light source originally emits polarized light include cases of a polarized light source and reflected light from a substrate at a Brewster's angle.

The liquid crystal polarization interference element 16 is an optical element that acts as a λ/2 retardation plate for light in a specific wavelength range (specific wavelength) and does not act as a retardation plate (retardation layer) for the other light.

As described above, the first polarizer 12 and the second polarizer 14 are polarizers that are arranged in a crossed nicols state with transmission axes being orthogonal to each other.

In the light incident onto the filter 10, only the linearly polarized light in the direction corresponding to the transmission axis transmits through the first polarizer 12. In the linearly polarized light, the polarization direction of light having a specific wavelength is rotated by 90° by the liquid crystal polarization interference element 16, and the light having a specific wavelength enters and transmits through the second polarizer 14 arranged in a crossed nicols state with respect to the first polarizer 12. In contrast, the liquid crystal polarization interference element 16 does not act as a retardation plate for light in a wavelength range other than the specific wavelength range. Accordingly, the light is incident onto the second polarizer 14 arranged in a crossed nicols state with respect to the first polarizer 12 and is shielded.

With such an optical action, the filter 10 functions as a band-pass filter that transmits only light in a specific wavelength range and shields other light.

The liquid crystal polarization interference element 16 is configured such that two or more liquid crystal layer sets 26 are laminated in the thickness direction, the one liquid crystal layer set 26 being a combination of the first liquid crystal layer 20 and the second liquid crystal layer 24. Accordingly, the total number of the first liquid crystal layers 20 and the second liquid crystal layers 24 laminated is an even number.

That is, the liquid crystal polarization interference element 16 is configured such that the same first liquid crystal layers 20 and the same second liquid crystal layers 24 are alternately laminated.

The first liquid crystal layer 20 has a rod-like liquid crystal layer 20R1 and a disk-like liquid crystal layer 20D1. The rod-like liquid crystal layer 20R1 corresponds to the liquid crystal layer R1 in the embodiment of the present invention, and the disk-like liquid crystal layer 20D1 corresponds to the liquid crystal layer D1 in the embodiment of the present invention.

The second liquid crystal layer 24 has a rod-like liquid crystal layer 24R2 and a disk-like liquid crystal layer 24D2. The rod-like liquid crystal layer 24R2 corresponds to the liquid crystal layer R2 in the embodiment of the present invention, and the disk-like liquid crystal layer 24D2 corresponds to the liquid crystal layer D2 in the embodiment of the present invention.

The rod-like liquid crystal layer 20R1 and the rod-like liquid crystal layer 24R2 are both liquid crystal layers formed by immobilizing the rod-like liquid crystal compounds 18R with horizontal alignment.

Both the disk-like liquid crystal layer 20D1 and the disk-like liquid crystal layer 24D2 are liquid crystal layers formed by immobilizing the disk-like liquid crystal compounds 18D with vertical alignment.

In the following description, in a case where it is not necessary to distinguish between the rod-like liquid crystal layer 20R1 and the rod-like liquid crystal layer 24R2, the both are collectively referred to as a “rod-like liquid crystal layer”. In addition, in the following description, in a case where it is not necessary to distinguish between the disk-like liquid crystal layer 20D1 and the disk-like liquid crystal layer 24D2, the both are collectively referred to as a “disk-like liquid crystal layer”.

Furthermore, in the present invention, the boundary between the rod-like liquid crystal layer and the disk-like liquid crystal layer in the first liquid crystal layer 20 and the second liquid crystal layer 24 can be detected by a method of performing observation with a scanning electron microscope (SEM), a method of analyzing a liquid crystal compound on a surface of a cross section obtained by obliquely cutting the liquid crystal polarization interference element 16, or other methods.

The method of analyzing each liquid crystal layer by obliquely cutting the liquid crystal polarization interference element 16 is described in detail in “Depth-Dependent Determination of Molecular Orientation for WV-Film” (FMC8-3, IDW '04, 651 to 654) by Yohei Takahashi, et al.

In the first liquid crystal layer 20, the in-plane slow axis of the rod-like liquid crystal layer 20R1 and the in-plane slow axis of the disk-like liquid crystal layer 20D1 are parallel to each other.

In addition, in the second liquid crystal layer 24, the in-plane slow axis of the rod-like liquid crystal layer 24R2 and the in-plane slow axis of the disk-like liquid crystal layer 24D2 are parallel to each other.

Furthermore, in the present invention, the term “parallel” includes not only a case where two axes are completely parallel to each other but also a case where an angle formed between two axes is more than 0° and 10° or less.

The in-plane slow axes of the rod-like liquid crystal layer and the disk-like liquid crystal layer can be detected by the method of performing the observation with an SEM and the method of performing analysis by obliquely cutting the liquid crystal polarization interference element 16, each described above.

In addition, in the liquid crystal polarization interference element 16, the in-plane slow axis of the rod-like liquid crystal layer 20R1 of the first liquid crystal layer 20 and the in-plane slow axis of the rod-like liquid crystal layer 24R2 of the second liquid crystal layer 24 intersect with each other.

Specifically, the in-plane slow axis in the rod-like liquid crystal layer 20R1 and the in-plane slow axis in the rod-like liquid crystal layer 24R2 are tilted in opposite directions at the same angle with respect to a certain reference line.

More specifically, the direction of the in-plane slow axis of the liquid crystal layer is, for example, set to 0° for the direction of the reference line, positive (+) for counterclockwise rotation, and negative (−) for clockwise rotation, and as an example, in a case where the angle formed between the reference line and the in-plane slow axis of the rod-like liquid crystal layer 20R1 is “φ[°]”, the angle formed between the reference line and the in-plane slow axis of the rod-like liquid crystal layer 24R2 is “−φ[°]”.

That is, the absolute values of an angle formed between the reference line and the in-plane slow axis of the rod-like liquid crystal layer 20R1 and an angle formed between the reference line and the in-plane slow axis of the rod-like liquid crystal layer 24R2 are equal to each other.

In the filter 10 in the example shown in the drawing, as one example, taking the transmission axis of the first polarizer 12 as a reference line, the angle formed between the transmission axis of the first polarizer 12 and the in-plane slow axis of the rod-like liquid crystal layer 20R1 in the first liquid crystal layer 20 of the liquid crystal polarization interference element 16 is “φ[°]”, and the angle formed between the transmission axis of the first polarizer 12 and the in-plane slow axis of the rod-like liquid crystal layer 24R2 in the second liquid crystal layer 24 of the liquid crystal polarization interference element 16 is “−φ[°]”.

In other words, the filter 10 is configured such that a bisector of the angle formed between the in-plane slow axis of the rod-like liquid crystal layer 20R1 and the in-plane slow axis of the rod-like liquid crystal layer 24R2 in the liquid crystal polarization interference element 16 coincides with the transmission axis (reference line) of the first polarizer 12.

Furthermore, in the filter 10 of the embodiment of the present invention, the reference line is not limited to the transmission axis of the first polarizer 12. As an example, in the filter 10 of the embodiment of the present invention, the reference line may be any of the absorption axis of the first polarizer 12, the transmission axis of the second polarizer 14, and the absorption axis of the second polarizer 14.

In the liquid crystal polarization interference element 16 in which the same first liquid crystal layers 20 and second liquid crystal layers 24 are alternately laminated such as the liquid crystal polarization interference element 16 shown in FIG. 1, the absolute value [°] of the angle formed between the reference line, the in-plane slow axis of the rod-like liquid crystal layer 20R1, and the in-plane slow axis of the rod-like liquid crystal layer 24R2 may be determined by the following expression, depending on the revolution angle (optical rotation angle) of the linearly polarized light as a target of the liquid crystal polarization interference element 16, and the number of the first liquid crystal layers 20 and the second liquid crystal layers 24 included in the liquid crystal polarization interference element 16.

That is, since the revolution angle of the linearly polarized light as the target of the liquid crystal polarization interference element 16 is typically 90°,
an absolute value of the angle formed between the reference line and the in-plane slow axis of the rod-like liquid crystal layer 20R1 and the in-plane slow axis of the rod-like liquid crystal layer 24R2 can be determined by the following expression:

90÷(the number of the first liquid crystal layer 20 and the second liquid crystal layer 24)÷2.

For example, in a case where the number of the first liquid crystal layers 20 and the second liquid crystal layers 24 is 8, that is, the number of the liquid crystal layer sets 26 is 4, the expression of “90÷8÷2=5.625” is obtained.

Accordingly, in the case of the above-described example, the angle formed between the transmission axis of the first polarizer 12 and the in-plane slow axis of the rod-like liquid crystal layer 20R1 in the first liquid crystal layer 20 is 5.625°, and the angle formed between the transmission axis of the first polarizer 12 and the in-plane slow axis of the rod-like liquid crystal layer 24R2 in the second liquid crystal layer 24 is −5.625°.

The number of the first liquid crystal layers 20 and the second liquid crystal layers 24, that is, the number of the liquid crystal layer sets 26 included in the liquid crystal polarization interference element 16 can be detected by the above-described method of performing observation with an SEM and the method of obliquely cutting the liquid crystal polarization interference element 16.

Furthermore, in the liquid crystal polarization interference element 16 of the embodiment of the present invention, the absolute values of the angle formed between the reference line and the in-plane slow axis in the rod-like liquid crystal layer 20R1 and the angle formed between the reference line and the in-plane slow axis in the rod-like liquid crystal layer 24R2 are not necessarily required to completely coincide, and may have an error of ±10° or less.

It should be noted that it is preferable that the error is small, and it is most preferable that the absolute values of the angles formed between the in-plane slow axis of the rod-like liquid crystal layer 20R1 and the in-plane slow axis of the rod-like liquid crystal layer 24R2 coincide.

In the liquid crystal polarization interference element 16, the rod-like liquid crystal layer 20R1 and the disk-like liquid crystal layer 20D1 of the first liquid crystal layer 20 have equal in-plane retardations (Re).

In addition, in the liquid crystal polarization interference element 16, the rod-like liquid crystal layer 24R2 and the disk-like liquid crystal layer 24D2 of the second liquid crystal layer 24 have equal in-plane retardations.

Furthermore, the first liquid crystal layer 20 and the second liquid crystal layer 24 in the example shown in the drawing each include one rod-like liquid crystal layer and one disk-like liquid crystal layer. However, as will be described later, the first liquid crystal layer and the second liquid crystal layer may have a plurality of rod-like liquid crystal layers and a plurality of disk-like liquid crystal layers although the present invention is not limited thereto. In this case, in the first liquid crystal layer 20 and the second liquid crystal layer 24, a sum of the in-plane retardations of the plurality of rod-like liquid crystal layers and a sum of the in-plane retardations of the plurality of disk-like liquid crystal layers are equal to each other.

In this case, it is preferable that one liquid crystal layer is further divided into a region (rod-like liquid crystal layer) consisting of the rod-like liquid crystal compounds 18R and a region (disk-like liquid crystal layer) consisting of the disk-like liquid crystal compounds 18D to increase the number of the liquid crystal layers. This makes it possible to reduce the difference between the retardation at the front surface (normal line) and the retardation at the polar angle with respect to a wider oblique orientation which is more oblique.

Further, in the liquid crystal polarization interference element 16 of the embodiment of the present invention, it is preferable that the in-plane retardation of the first liquid crystal layer 20 and the in-plane retardation of the second liquid crystal layer 24 are equal to each other.

Furthermore, in the present invention, the in-plane retardations being the equal are not limited to the in-plane retardations completely coinciding and may have an error of 10% or less.

It should be noted that the error is preferably small, and the in-plane retardation of the rod-like liquid crystal layer and the disk-like liquid crystal layer in the first liquid crystal layer 20 and the second liquid crystal layer 24 and the in-plane retardations of the first liquid crystal layer 20 and the second liquid crystal layer 24 preferably completely coincide.

Furthermore, the liquid crystal polarization interference element of the embodiment of the present invention is not limited to a configuration in which the in-plane retardation of the first liquid crystal layer and the in-plane retardation of the second liquid crystal layer are equal to each other.

For example, in a case where the sum of the in-plane retardations of the first liquid crystal layer and the second liquid crystal layer satisfies a desired value of the retardation of the present invention, the in-plane retardations of the first liquid crystal layer and the in-plane retardations of the second liquid crystal layer may be different from each other. Examples of the desired value of the retardation of the present invention include a retardation value of a half-wavelength.

In the liquid crystal polarization interference element 16, the measurement wavelength of the in-plane retardation is determined as follows, for example.

Two polarizers are arranged in a crossed nicols state and the liquid crystal polarization interference element 16 is arranged therebetween. In this case, the transmission axis or the absorption axis of one of the polarizers arranged in a crossed nicols state is aligned with the bisector of the angle formed between the in-plane slow axis of the rod-like liquid crystal layer 20R1 and the in-plane slow axis of the rod-like liquid crystal layer 24R2. In this state, the transmittance is measured at each wavelength and the wavelength having the highest transmittance is set as the measurement wavelength of the in-plane retardation.

In addition, the in-plane retardation of each liquid crystal layer may be measured by a known method such as a method using AxoScan manufactured by Axometrics, Inc.

Alternatively, the in-plane retardation of each liquid crystal layer may be calculated with Δnd. In Δnd, Δn is the birefringence of the liquid crystal compound 18 that constitutes the liquid crystal layer. In addition, d is the thickness of the liquid crystal layer.

In the liquid crystal polarization interference element 16, it is preferable that the in-plane retardations of the rod-like liquid crystal layer and the disk-like liquid crystal layer are the half of the half-wavelength of the wavelength of light at which the liquid crystal polarization interference element 16 is assumed to act as a λ/2 retardation plate. That is, it is preferable that the in-plane retardations of the first liquid crystal layer 20 and the second liquid crystal layer 24 are the half-wavelength of the wavelength of light at which the liquid crystal polarization interference element 16 is assumed to act as a λ/2 retardation plate.

For example, in a case where the wavelength of light at which the liquid crystal polarization interference element 16 is assumed to act as a λ/2 retardation plate is 550 nm, the in-plane retardations of the rod-like liquid crystal layer and the disk-like liquid crystal layer are preferably 137.5 nm. Accordingly, in this case, the in-plane retardations of the first liquid crystal layer 20 and the second liquid crystal layer 24 are preferably 275 nm.

By allowing the liquid crystal polarization interference element 16 of the embodiment of the present invention to have such a configuration, the liquid crystal polarization interference element 16 acts as a λ/2 retardation plate for light in a specific wavelength range.

As described above, the liquid crystal polarization interference element 16 is configured such that the rod-like liquid crystal layer consisting of the rod-like liquid crystal compounds 18R and the disk-like liquid crystal layer consisting of the disk-like liquid crystal compounds 18D are provided, and the first liquid crystal layer 20 and the second liquid crystal layer 24, having opposite directions of the in-plane slow axes and having equal absolute values of the angles of the in-plane slow axes with respect to the reference line, are alternately laminated. That is, the liquid crystal polarization interference element 16 is configured such that the rod-like liquid crystal layer and the disk-like liquid crystal layer are provided, and the first liquid crystal layer 20 and the second liquid crystal layer 24, having angles of the in-plane slow axes with respect to the reference line of “φ” and “−φ”, respectively, are alternately laminated.

The light that passes through the liquid crystal polarization interference element 16 is alternately and repeatedly influenced by the in-plane slow axis having an angle of “φ” with respect to the reference line and by the in-plane slow axis having an angle of “−φ” with respect to the reference line.

For example, in a case where the absolute value of the angle with respect to the reference line is 5.625°, the light that has passed through the liquid crystal polarization interference element 16 is alternately and repeatedly influenced by the rotation by in-plane slow axis having an angle of 5.625° with respect to the reference line, and then by the in-plane slow axis having an angle of −5.625° with respect to the reference line.

Therefore, the in-plane retardations of the first liquid crystal layer 20 and the second liquid crystal layer 24 are set as described above depending on the wavelength of light for which the liquid crystal polarization interference element 16 acts as a λ/2 retardation plate, and further, the angle between the in-plane slow axes in the first liquid crystal layer 20 and the second liquid crystal layer 24 is adjusted depending on the number of the first liquid crystal layers 20 and the second liquid crystal layers 24. This makes it possible to form the liquid crystal polarization interference element 16 that acts as a λ/2 retardation plate for light in a specific wavelength range and does not act as a retardation plate for the other light, that is, does not sense an in-plane retardation.

Therefore, by arranging the liquid crystal polarization interference element of the embodiment of the present invention between the two polarizers arranged in a crossed nicols state such that the transmission axis or the absorption axis of one polarizer coincides with the bisector of the angle formed between the in-plane slow axes of the first liquid crystal layer 20 and the second liquid crystal layer 24, it is possible to obtain a band-pass filter that allows only light in a specific wavelength range among the linearly polarized light transmitted through one polarizer to be revolved (optically rotated) by λ/2 and emitted from the other polarizer.

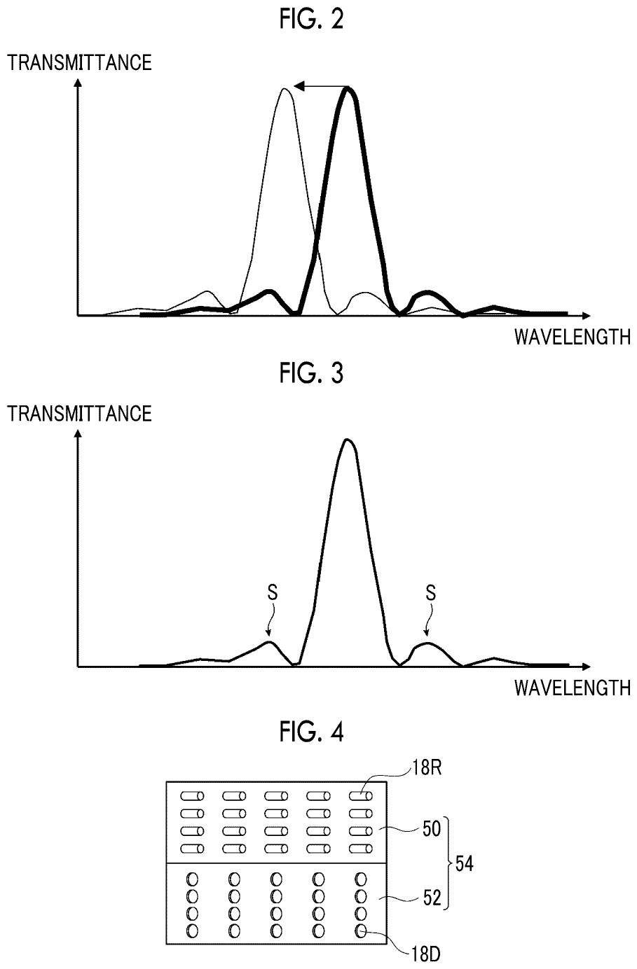

Here, as described above, in the band-pass filter in the related art, there is a problem in that there occurs a fluctuation in wavelength of light at which the maximum transmittance is exhibited, that is, a so-called wavelength shift, as conceptually shown in FIG. 2, upon incidence of light from an oblique direction.

In contrast, in the liquid crystal polarization interference element 16 of the embodiment of the present invention, the first liquid crystal layer 20 and the second liquid crystal layer 24 each have a rod-like liquid crystal layer consisting of rod-like liquid crystal compounds 18R and a disk-like liquid crystal layer consisting of disk-like liquid crystal compounds 18D, and the in-plane retardation of the rod-like liquid crystal layer and the in-plane retardation of the disk-like liquid crystal layer are equal to each other.

Therefore, in the first liquid crystal layer 20 and the second liquid crystal layer 24, the thickness-direction retardation (Rth) of the rod-like liquid crystal layer can be offset by the thickness-direction retardation of the disk-like liquid crystal layer.

As a result, by using the liquid crystal polarization interference element 16 of the embodiment of the present invention as a band-pass filter, it is possible to suppress a wavelength shift, which is a fluctuation in wavelength of light at which the maximum transmittance is exhibited even upon incidence of light from an oblique direction.

In the present invention, the thicknesses of the first liquid crystal layer 20 and the second liquid crystal layer 24 are not limited, and the thicknesses with which a desired in-plane retardation can be obtained may be appropriately set depending on the rod-like liquid crystal compound 18R and the disk-like liquid crystal compound 18D used.

Furthermore, the first liquid crystal layer 20 and the second liquid crystal layer 24 are usually formed by using the same liquid crystal compound. In addition, as described above, the in-plane retardations of the first liquid crystal layer 20 and the second liquid crystal layer 24 are equal to each other. Accordingly, the thicknesses of the first liquid crystal layer 20 and the second liquid crystal layer 24 are usually equal to each other.

In addition, the thicknesses of the rod-like liquid crystal layer 20R1 and the disk-like liquid crystal layer 20D1 in the first liquid crystal layer 20 and the thicknesses of the rod-like liquid crystal layer 24R2 and the disk-like liquid crystal layer 24D2 in the second liquid crystal layer 24 are not limited.

That is, the thicknesses of the rod-like liquid crystal layer and the disk-like liquid crystal layer in the first liquid crystal layer 20 and the second liquid crystal layer 24 may be appropriately set such that a desired in-plane retardation is obtained depending on the liquid crystal compound used.

Here, it is preferable that Δn of the rod-like liquid crystal compounds 18R forming the rod-like liquid crystal layer and Δn of the disk-like liquid crystal compounds 18D forming the disk-like liquid crystal layer are close to each other, and it is more preferable that Δn of the rod-like liquid crystal compounds 18R and Δn of the disk-like liquid crystal compounds 18D are equal to each other. Accordingly, it is preferable that the thicknesses of the rod-like liquid crystal layer and the disk-like liquid crystal layer in the first liquid crystal layer 20 and the second liquid crystal layer 24 are equal to each other.

In the present invention, the thicknesses of the first liquid crystal layer 20 and the second liquid crystal layer 24 are thicknesses corresponding to the above-described thicknesses of the rod-like liquid crystal layer and disk-like liquid crystal layer.

Furthermore, the first liquid crystal layer 20 and the second liquid crystal layer 24 are usually formed by using the same liquid crystal compound. In addition, as described above, the in-plane retardations of the first liquid crystal layer 20 and the second liquid crystal layer 24 are equal to each other. Accordingly, the thicknesses of the first liquid crystal layer 20 and the second liquid crystal layer 24 are usually equal to each other.

Here, the thicknesses of the first liquid crystal layer 20 and the second liquid crystal layer 24 are preferably 1 to 5 μm, and more preferably 1 to 3 μm.

Accordingly, the thicknesses of the rod-like liquid crystal layer and the disk-like liquid crystal layer in the first liquid crystal layer 20 and the second liquid crystal layer 24 are preferably 0.5 to 2.5 μm, and more preferably 0.5 to 1.5 μm.

The total number of the first liquid crystal layers 20 and the second liquid crystal layers 24 laminated is not limited as long as the number of the liquid crystal layer sets 26 is 2 or more, that is, four or more layers are laminated, and further the number of layers laminated is an even number.

The total number of the first liquid crystal layers 20 and the second liquid crystal layers 24 laminated is preferably 6 to 30, more preferably 6 to 20, and still more preferably 6 to 10.

Furthermore, in the liquid crystal polarization interference element of the embodiment of the present invention, the larger the total number of the first liquid crystal layers 20 and the second liquid crystal layers 24 laminated, that is, the larger the number of the liquid crystal layer sets 26, the narrower the wavelength range in which the liquid crystal polarization interference element 16 acts as the λ/2 retardation plate.

Accordingly, in the liquid crystal polarization interference element of the embodiment of the present invention, the larger the total number of the first liquid crystal layers 20 and the second liquid crystal layers 24 laminated, the narrower the half-width of the wavelength range of the transmitted light. In other words, the filter 10 can be made as a band-pass filter having a narrower transmission wavelength range as the total number N of the first liquid crystal layers 20 and the second liquid crystal layers 24 laminated is increased.

Accordingly, as the total number N of the first liquid crystal layers 20 and the second liquid crystal layers 24 laminated, that is, the number of the liquid crystal layer sets 26, a smaller number of layers may be selected for a case where a broad bandwidth is required, and a larger number of layers may be selected for a case where a narrow bandwidth is required, depending on a required width of the transmission wavelength range of the filter 10.

The liquid crystal polarization interference element 16 including the first liquid crystal layer 20 and the second liquid crystal layer 24 may be manufactured by a known method.

For example, the liquid crystal polarization interference element 16 is manufactured by a coating method using a liquid crystal composition for forming a rod-like liquid crystal layer and a disk-like liquid crystal layer.

First, an alignment film aligned in one direction is formed on an appropriately selected support.

As the alignment film, known alignment films can be used, such as a rubbed film consisting of an organic compound such as a polymer, an obliquely vapor-deposited film of an inorganic compound, a film having microgrooves, and a film obtained by accumulating a Langmuir-Blodgett (LB) film of an organic compound such as ω-tricosanoic acid, dioctadecylmethylammonium chloride, and methyl stearate by a Langmuir-Blodgett method, and a film obtained by applying a coating liquid for forming an alignment film containing a photo alignment material to a surface of a support, drying the coating liquid, and exposing the coating film using a polarizer such as a wire grid polarizer.

On the other hand, a liquid crystal composition for forming a rod-like liquid crystal layer including the rod-like liquid crystal compounds 18R, and a liquid crystal composition for forming a disk-like liquid crystal layer including the disk-like liquid crystal compounds 18D are prepared.

Furthermore, a solvent for preparing the composition is not limited and can be appropriately selected depending on the purpose, but is preferably an organic solvent. The organic solvent is not particularly limited and can be appropriately selected depending on the purpose. Examples of the organic solvent include ketones, alkyl halides, amides sulfoxides, a heterocyclic compound, hydrocarbons, esters, and ethers. These may be used alone or in combination of two or more kinds thereof. Among these, the ketones are preferable in consideration of an environmental burden.

After the liquid crystal composition is prepared, in order to form a disk-like liquid crystal layer, the liquid crystal composition is applied onto the alignment film to align the disk-like liquid crystal compounds 18D, further dried, and cured by ultraviolet irradiation or the like as necessary to form a disk-like liquid crystal layer 20D1.

Next, a liquid crystal composition for forming a rod-like liquid crystal compound is applied onto the disk-like liquid crystal layer 20D1 to align the rod-like liquid crystal compounds 18R, further dried, and is cured by ultraviolet irradiation or the like as necessary to form a rod-like liquid crystal layer 20R1, thereby forming the first liquid crystal layer 20.

Here, in a case where a liquid crystal layer is formed on the liquid crystal layer using the coating method, the alignment of the upper liquid crystal layer follows the alignment of the liquid crystal compounds on a surface of the lower liquid crystal layer. The alignment directions of the liquid crystal compounds in the disk-like liquid crystal layer 20D1 and the rod-like liquid crystal layer 20R1 coincide, that is, the in-plane slow axes are parallel to each other.

Further, in the same manner, the liquid crystal composition is applied onto the alignment film to form a disk-like liquid crystal layer, and the liquid crystal composition for forming a rod-like liquid crystal compound is applied thereonto to form a rod-like liquid crystal layer.

The laminate of the two liquid crystal layers is peeled off from the alignment film, and the laminate is laminated on the first liquid crystal layer 20 (rod-like liquid crystal layer 20R1) formed in advance, and bonded with OCA or the like.

In this case, the laminate is laminated on the first liquid crystal layer 20 such that the in-plane slow axis of the rod-like liquid crystal layer 20R1 of the first liquid crystal layer 20 and the in-plane slow axis of the rod-like liquid crystal layer in the laminate to be laminated form a predetermined angle.

For example, as described above, in a case where the angle formed between the reference line and the in-plane slow axis of the rod-like liquid crystal layer 20R1 of the first liquid crystal layer 20 is 5.625° and the angle formed between the reference line and the in-plane slow axis of the rod-like liquid crystal layer 20R1 of the second liquid crystal layer 24 is −5.625°, the laminate is laminated on the first liquid crystal layer 20 such that the angle formed between the in-plane slow axis of the rod-like liquid crystal layer 20R1 of the first liquid crystal layer 20 and the in-plane slow axis of the rod-like liquid crystal layer of the laminate is 11.25°.

As a result, the liquid crystal layer set 26 in which the first liquid crystal layer 20 including the rod-like liquid crystal layer 20R1 and the disk-like liquid crystal layer 20D1, and the second liquid crystal layer 24 including the rod-like liquid crystal layer 24R2 and the disk-like liquid crystal layer 24D2 are laminated can be formed.

Further, in the same manner, the liquid crystal composition is applied onto the alignment film to form a disk-like liquid crystal layer, and the liquid crystal composition for forming a rod-like liquid crystal compound is applied thereonto to form a rod-like liquid crystal layer. Thereafter, the laminate of the two liquid crystal layers is peeled off from the alignment film, the angle of the in-plane slow axis of the rod-like liquid crystal layer is adjusted in the same manner as above, and the second liquid crystal layer 24 (rod-like liquid crystal layer 24R2) is thus laminated and bonded.

By repeating such the lamination of the laminate as many times as the number of the first liquid crystal layers 20 and the second liquid crystal layers 24 to be laminated, that is, the number of the liquid crystal layer sets 26 to be laminated, the liquid crystal polarization interference element 16 as shown in FIG. 1 can be manufactured.

After the liquid crystal polarization interference element 16 is manufactured in the manner as above, the first polarizer 12 and the second polarizer 14 arranged in a crossed nicols state, with the liquid crystal polarization interference element 16 being sandwiched, such that a bisector of an angle formed between the in-plane slow axis of the rod-like liquid crystal layer 20R1 of the first liquid crystal layer 20 and the in-plane slow axis of the rod-like liquid crystal layer 24R2 of the second liquid crystal layer 24 coincides with, for example, the transmission axis of the first polarizer 12.

This makes it possible to manufacture the filter 10 (band-pass filter) as shown in FIG. 1.

Furthermore, in the liquid crystal polarization interference element of the embodiment of the present invention, the method for manufacturing the first liquid crystal layer and the second liquid crystal layer is not limited to this method.

For example, in the liquid crystal polarization interference element of the embodiment of the present invention, the first liquid crystal layer and the second liquid crystal layer may be formed by a coating method and directly laminated. Alternatively, in the liquid crystal polarization interference element of the embodiment of the present invention may be provided by manufacturing a sheet-like first liquid crystal layer and a sheet-like second liquid crystal layer, and alternately laminating and bonding them to each other with an optical bonding layer transparent to transmitted light, such as an OCA, an acrylic pressure sensitive adhesive, an adhesive, and a polymer layer.

At this time, the refractive index of the optical bonding layer is preferably close to the refractive index of the liquid crystals from the viewpoint of improving a transmittance. Specifically, the difference between the refractive index of the optical bonding layer and the refractive index of the liquid crystal is preferably 0.3 or less. In addition, the refractive index of the optical bonding layer is preferably a value between two birefringence indices of the liquid crystals since the difference in refractive index is small from either of the two birefringence indices.

Further, from the viewpoint of the transmittance of the transmitted light transmitted through the liquid crystal polarization interference element, the first liquid crystal layer and the second liquid crystal layer directly laminated by the coating method without the bonding layer or the like are preferable.

In the liquid crystal polarization interference element 16 of the embodiment of the present invention, the rod-like liquid crystal compound 18R is not limited and various known liquid crystal compounds can be used.

As the rod-like liquid crystal compound, azomethines, azoxys, cyanobiphenyls, cyanophenyl esters, benzoic acid esters, cyclohexanecarboxylic acid phenyl esters, cyanophenylcyclohexanes, cyano-substituted phenylpyrimidines, alkoxy-substituted phenylpyrimidines, phenyldioxanes, tolanes, and alkenylcyclohexylbenzonitriles are preferably used. As the rod-like liquid crystal compound, not only the low-molecular-weight liquid crystal molecules as described above but also high-molecular-weight liquid crystal molecules can be used.

It is preferable that the alignment of the rod-like liquid crystal compound is immobilized by polymerization, and as the polymerizable rod-like liquid crystal compound, the compounds described in Makromol. Chem., Vol. 190, p. 2255 (1989), Advanced Materials, Vol. 5, p. 107 (1993), U.S. Pat. Nos. 4,683,327A, 5,622,648A, 5,770,107A, WO95/22586A, WO95/24455A, WO97/00600A, WO98/23580A, WO98/52905A, JP1989-272551A (JP-H01-272551A), JP1994-16616A (JP-H06-16616A), JP1995-110469A (JP-H07-110469A), JP1999-80081A (JP-H11-80081A), JP2001-64627A, and the like can be used. Furthermore, as the rod-like liquid crystal compound, for example, the compounds described in JP1999-513019A (JP-H11-513019A) and JP2007-279688A can also be preferably used.

The disk-like liquid crystal compound 18D is not limited and various known compounds can be used.

As the disk-like liquid crystal compound 18D, for example, the compounds described in JP2007-108732A and JP2010-244038A can be preferably used.

Furthermore, it is preferable that the alignment of the disk-like liquid crystal compounds 18D is also fixed by polymerization.

In the liquid crystal polarization interference element shown in FIG. 1, both the first liquid crystal layer 20 and the second liquid crystal layer 24 have one rod-like liquid crystal layer and one disk-like liquid crystal layer.

However, the present invention is not limited thereto. For example, the first liquid crystal layer 20 and the second liquid crystal layer 24 may have a plurality of rod-like liquid crystal layers and disk-like liquid crystal layers, such as a configuration in which the first liquid crystal layer 20 and the second liquid crystal layer 24 have two rod-like liquid crystal layers and two disk-like liquid crystal layers, such as rod-like liquid crystal layer/disk-like liquid crystal layer/rod-like liquid crystal layer/disk-like liquid crystal layer.

As described above, in a case where the first liquid crystal layer 20 and the second liquid crystal layer 24 have a plurality of rod-like liquid crystal layers and disk-like liquid crystal layers, the number of each of the layers is not limited.

Optically, it is preferable that the number of the rod-like liquid crystal layers and the disk-like liquid crystal layers, which constitute the first liquid crystal layer 20 and the second liquid crystal layer 24, is large. As the number of the rod-like liquid crystal layers and the disk-like liquid crystal layers, that constitute the first liquid crystal layer 20 and the second liquid crystal layer 24, is larger, the mutual compensation (optical compensation) between the disk-like liquid crystals and rod-like liquid crystals can be achieved more precisely over smaller regions. As a result, the wavelength shift upon incidence of light from an oblique direction can be further reduced in a state where the bias in the thickness direction is small and more uniform.

As described above, in the liquid crystal polarization interference element of the embodiment of the present invention, in a case where the first liquid crystal layer 20 and the second liquid crystal layer 24 have a plurality of rod-like liquid crystal layers and disk-like liquid crystal layers, a sum of the in-plane retardations of the rod-like liquid crystal layers and a sum of the in-plane retardations of the disk-like liquid crystal layers are equal to each other.

Here, as long as where the sum of the in-plane retardations of the rod-like liquid crystal layers and the sum of the in-plane retardations of the disk-like liquid crystal layers are equal to each other, the number of the rod-like liquid crystal layers and the number of the disk-like liquid crystal layers may be different from each other in the first liquid crystal layer 20 and the second liquid crystal layer 24. However, it is preferable that the number of the rod-like liquid crystal layers and the number of the disk-like liquid crystal layers are equal to each other in the first liquid crystal layer 20 and the second liquid crystal layer 24.

In addition, in the liquid crystal polarization interference element of the embodiment of the present invention, it is preferable that the in-plane retardation of the first liquid crystal layer 20 and the in-plane retardation of the second liquid crystal layer 24 are equal to each other.

In this case, as long as the in-plane retardation of the first liquid crystal layer 20 and the in-plane retardation of the second liquid crystal layer 24 are equal to each other, the number of the rod-like liquid crystal layers 20R1 and the number of the disk-like liquid crystal layers 20D1 in the first liquid crystal layer 20, and the number of the rod-like liquid crystal layers 24R2 and the number of the disk-like liquid crystal layers 24D2 in the second liquid crystal layer 24 may be different from each other. However, it is preferable that the number of the rod-like liquid crystal layers 20R1 and the number of the disk-like liquid crystal layers 20D1 in the first liquid crystal layer 20, and the number of the rod-like liquid crystal layers 24R2 and the number of the disk-like liquid crystal layers 24D2 in the second liquid crystal layer 24 are equal to each other.

Further, in the first liquid crystal layer 20 and the second liquid crystal layer 24, as long as the sum of the in-plane retardations of the rod-like liquid crystal layers and the sum of the in-plane retardations of the disk-like liquid crystal layers are equal to each other, the number of the rod-like liquid crystal layers and the number of the disk-like liquid crystal layers may be different from each other. However, in the first liquid crystal layer 20 and the second liquid crystal layer 24, it is preferable that the number of the rod-like liquid crystal layers and the number of the disk-like liquid crystal layers are equal to each other.

The liquid crystal polarization interference element 16 shown in FIG. 1 is formed by alternately laminating the same first liquid crystal layers 20 and the same second liquid crystal layers 24. That is, in the liquid crystal polarization interference element 16, all of the first liquid crystal layers 20 are the same as each other, and all of the second liquid crystal layers 24 are also the same as each other.

Accordingly, in the liquid crystal polarization interference element 16 shown in FIG. 1, the in-plane retardations of all of the first liquid crystal layers 20 are equal to each other, and the in-plane slow axes of the rod-like liquid crystal layer and the disk-like liquid crystal layer are parallel to each other. In the same manner, in the liquid crystal polarization interference element 16 shown in FIG. 1, the in-plane retardations of all of the second liquid crystal layers 24 are equal to each other, and the in-plane slow axes of the rod-like liquid crystal layer and the disk-like liquid crystal layer are parallel to each other.

However, the liquid crystal polarization interference element of the embodiment of the present invention is not limited thereto, and may have a first liquid crystal layer in which the in-plane retardations are different from each other and the in-plane slow axes are not parallel to each other. In addition, the liquid crystal polarization interference element of the embodiment of the present invention may have a second liquid crystal layer in which the in-plane retardations are different from each other and the in-plane slow axes are not parallel to each other.

That is, as the liquid crystal polarization interference element of the embodiment of the present invention, as long as the in-plane slow axes of the rod-like liquid crystal layer and the disk-like liquid crystal layer are parallel to each other, the in-plane retardations (sum) of the rod-like liquid crystal layers and the in-plane retardations (sum) of the disk-like liquid crystal layers are equal to each other in the first liquid crystal layer and the second liquid crystal layer, and further, the in-plane slow axes of the rod-like liquid crystal layers of the first liquid crystal layer and the second liquid crystal layer intersect with each other, and the in-plane retardations of the first liquid crystal layer and the second liquid crystal layer are equal to each other, there may exist the liquid crystal polarization interference element, in which the in-plane retardations, and the angle formed between the in-plane slow axis of the rod-like liquid crystal layer of the first liquid crystal layer and a reference line and the angle formed between the in-plane slow axis of the rod-like liquid crystal layer of the second liquid crystal layer and a reference line are different between the liquid crystal layer sets.

As an example, a configuration is exemplified, in which the in-plane retardations of the first liquid crystal layer and the second liquid crystal layer in the liquid crystal layer sets on both sides in the thickness direction are increased and the absolute values of the angle formed between the in-plane slow axis of the rod-like liquid crystal layer of the first liquid crystal layer and the reference line and the angle formed between the in-plane slow axis of the rod-like liquid crystal layer of the second liquid crystal layer and the reference line are decreased, as compared with the liquid crystal layer set in the central part in the thickness direction.

As described in Examples which will be later, for example, a configuration is exemplified, in which in a case where the liquid crystal polarization interference element has eight layers of the first liquid crystal layers and the second liquid crystal layers, that is, four liquid crystal layer sets,
in the first liquid crystal layer set, the in-plane retardation of the first liquid crystal layer (first layer) is denoted by Re1, the angle formed between the in-plane slow axis of the rod-like liquid crystal layer and the reference line is denoted by φ1, the in-plane retardation of the second liquid crystal layer (second layer) is denoted by Re1, and the angle formed between the in-plane slow axis of the rod-like liquid crystal layer and the reference line is denoted by −φ1.
in the second liquid crystal layer set, the in-plane retardation of the first liquid crystal layer (third layer) is denoted by Re2 which is smaller than Re1, the angle formed between the in-plane slow axis of the rod-like liquid crystal layer and the reference line is denoted by φ2 which is larger than φ1, the in-plane retardation of the second liquid crystal layer (fourth layer) is denoted by Re2 which is smaller than Re1, and the angle formed between the in-plane slow axis of the rod-like liquid crystal layer and the reference line is denoted by −φ2 which is larger than −φ1,
in the third liquid crystal layer set, the in-plane retardation of the first liquid crystal layer (fifth layer) is denoted by Re2, the angle formed between the in-plane slow axis of the rod-like liquid crystal layer and the reference line is denoted by φ2, the in-plane retardation of the second liquid crystal layer (sixth layer) is denoted by Re2, and the angle formed between the in-plane slow axis of the rod-like liquid crystal layer and the reference line is denoted by −φ2, and
in the fourth liquid crystal layer set, the in-plane retardation of the first liquid crystal layer (seventh layer) is denoted by Re1, the angle formed between the in-plane slow axis of the rod-like liquid crystal layer and the reference line is denoted by φ1, the in-plane retardation of the second liquid crystal layer (eighth layer) is denoted by Re1, and the angle formed between the in-plane slow axis of the rod-like liquid crystal layer and the reference line is denoted by −φ1.

In the band-pass filter, as conceptually shown in FIG. 3, an unnecessary transmission wavelength region, which is called a side lobe, is generated as shown by the arrow S in the drawing at a position of a shorter wavelength and a position of a longer wavelength than a target transmission wavelength range, with the target transmission wavelength range being sandwiched.

In contrast, as described above, in the liquid crystal polarization interference element, by increasing the in-plane retardations of the first liquid crystal layer and the second liquid crystal layer of the liquid crystal layer sets on both sides in the thickness direction, and decreasing the absolute value of the angle formed between the in-plane slow axis of the rod-like liquid crystal layer and the reference line, the side lobe can be reduced in a case where the liquid crystal polarization interference element is used in a band-pass filter, as compared with the liquid crystal layer of the liquid crystal layer set in the central part in the thickness direction.

In other words, in the liquid crystal polarization interference element of the embodiment of the present invention, by increasing the in-plane retardations of the first liquid crystal layer and the second liquid crystal layer of the liquid crystal layer sets on both sides in the thickness direction, and decreasing the angle formed between the in-plane slow axis of the rod-like liquid crystal layer of the first liquid crystal layer and the in-plane slow axis of the rod-like liquid crystal layer of the second liquid crystal layer, the side lobe can be reduced in a case where the liquid crystal polarization interference element is used in a band-pass filter, as compared with the liquid crystal layer of the liquid crystal layer set in the central part in the thickness direction.

Furthermore, the in-plane retardations of the first liquid crystal layer and the second liquid crystal layer may be adjusted by changing the thicknesses of the first liquid crystal layer and the second liquid crystal layer. Alternatively, the in-plane retardations may be adjusted by changing the liquid crystal compound to be used.

In addition, the angle formed between the in-plane slow axis of the rod-like liquid crystal layer and the reference line may be adjusted by adjusting the angle of the in-plane slow axis of the rod-like liquid crystal layer during lamination, for example, by the above-described production method.

In such a configuration in which the in-plane retardations of the first liquid crystal layer and the second liquid crystal layer are increased, and the absolute value of the angle formed between the in-plane slow axis of the rod-like liquid crystal layer and the reference line is decreased in the liquid crystal layer sets on both sides in the thickness direction, as compared with the liquid crystal layers of the liquid crystal layer sets in the center in the thickness direction, there is no limit on the number of the liquid crystal layer sets in the center, with which the in-plane retardations in the liquid crystal layers are increased and the absolute value of the angle formed between the in-plane slow axes of the rod-like liquid crystal layer and the reference line is decreased, that is, on how to divide the liquid crystal layer sets between the both sides and the central part, as compared with the both sides. Thus, the number or the division can be appropriately set depending on the number of the liquid crystal layers (liquid crystal layer sets) included in the liquid crystal polarization interference element.

In addition, there is no limit on the in-plane retardations of the first liquid crystal layer and the second liquid crystal layer, and the angle formed between the in-plane slow axis of the rod-like liquid crystal layer and the reference line in the liquid crystal layer sets in both sides in the thickness direction, as well as the in-plane retardations of the first liquid crystal layer and the second liquid crystal layer, and the angle formed between the in-plane slow axis of the rod-like liquid crystal layer and the reference line in the liquid crystal layer sets in the center in the thickness direction. That is, these angles may be set through, for example, simulation to achieve the optimal in-plane retardation and angle that allow the liquid crystal polarization interference element to act as a λ/2 retardation plate and make it possible to reduce the side lobes.

Furthermore, it is preferable that the change in the in-plane retardations of the first liquid crystal layer and the second liquid crystal layer from the both sides toward the center in the lamination direction (thickness direction) and the change in the angle formed between the in-plane slow axis of the rod-like liquid crystal layer and the reference line are controlled as gently and finely as possible.

A first aspect of the liquid crystal polarization interference element of the embodiment of the present invention is configured such that
the liquid crystal polarization interference element has two or more liquid crystal layer sets in a thickness direction, each set consisting of a first liquid crystal layer and a second liquid crystal layer,
the first liquid crystal layer includes at least one liquid crystal layer R1 formed by immobilizing horizontally aligned rod-like liquid crystal compounds, and at least one liquid crystal layer D1 formed by immobilizing vertically aligned disk-like liquid crystal compounds,
the second liquid crystal layer includes at least one liquid crystal layer R2 formed by immobilizing horizontally aligned rod-like liquid crystal compounds, and at least one liquid crystal layer D2 formed by immobilizing vertically aligned disk-like liquid crystal compounds,
an in-plane slow axis of the liquid crystal layer R1 and an in-plane slow axis of the liquid crystal layer D1 are parallel to each other,
an in-plane slow axis of the liquid crystal layer R2 and an in-plane slow axis of the liquid crystal layer D2 are parallel to each other,
the in-plane slow axis of the liquid crystal layer R1 and the in-plane slow axis of the liquid crystal layer R2 intersect with each other,
a sum of in-plane retardations of the liquid crystal layers R1 and a sum of in-plane retardations of the liquid crystal layers D1 are equal to each other, and
a sum of in-plane retardations of the liquid crystal layers R2 and a sum of in-plane retardations of the liquid crystal layers D2 are equal to each other.

In contrast, a second aspect of the liquid crystal polarization interference element of the embodiment of the present invention is configured such that
the liquid crystal polarization interference element has two or more liquid crystal layer sets in a thickness direction, each set consisting of a first liquid crystal layer and a second liquid crystal layer,
the first liquid crystal layer or the second liquid crystal layer includes at least one liquid crystal layer R (rod-like liquid crystal layer) including a rod-like liquid crystal compound,
the first liquid crystal layer or the second liquid crystal layer includes at least one liquid crystal layer D (disk-like liquid crystal layer) including a disk-like liquid crystal compound,
an in-plane slow axis of the first liquid crystal layer and an in-plane slow axis of the second liquid crystal layer intersect with each other, and
a sum of in-plane retardations of the first liquid crystal layers and a sum of in-plane retardations of the second liquid crystal layers are equal to each other.

Also in the second aspect of the liquid crystal polarization interference element of the embodiment of the present invention, by allowing the liquid crystal layer set to include the disk-like liquid crystal layer and the rod-like liquid crystal layer, for example, in a case where the liquid crystal polarization interference element is used as a band-pass filter in combination with a polarizer as shown in FIG. 1, it is possible to suppress a fluctuation in wavelength of light at which the maximum transmittance is exhibited upon incidence of light from an oblique direction, that is, a wavelength shift.

Furthermore, in the second aspect of the liquid crystal polarization interference element of the embodiment of the present invention, various components such as a rod-like liquid crystal compound and a disk-like liquid crystal compound, a composition for forming a liquid crystal layer, and the like basically follow the description of the first aspect of the liquid crystal polarization interference element of the embodiment of the present invention.

In addition, the direction (angle) of the in-plane slow axis in each of the liquid crystal layer sets, the in-plane retardation of each of the liquid crystal layers, the number of the liquid crystal layer sets, and the like may follow the description of the first aspect or may be different from the description.

In the second aspect of the liquid crystal polarization interference element of the embodiment of the present invention, various configurations different from the first aspect of the liquid crystal polarization interference element of the embodiment of the present invention can be used.

In the following description, “the second aspect of the liquid crystal polarization interference element of the embodiment of the present invention” will also be referred to as “the second aspect of the interference element of the embodiment of the present invention”.

As described above, in the second aspect of the interference element of the embodiment of the present invention, the first liquid crystal layer or the second liquid crystal layer includes at least one rod-like liquid crystal layer, and the first liquid crystal layer or the second liquid crystal layer includes at least one disk-like liquid crystal layer.

Accordingly, in the second aspect of the interference element of the embodiment of the present invention, for example, as conceptually shown in FIG. 4, the interference element may have two or more liquid crystal layer sets 54, each including a first liquid crystal layer 50 having only a rod-like liquid crystal layer consisting of rod-like liquid crystal compounds 18R and a second liquid crystal layer 52 having only a disk-like liquid crystal layer consisting of disk-like liquid crystal compounds 18D.

Alternatively, in the second aspect of the interference element of the embodiment of the present invention, the interference element may have two or more liquid crystal layer sets 54, each including a first liquid crystal layer (second liquid crystal layer) including only a rod-like liquid crystal layer and a second liquid crystal layer (first liquid crystal layer) including a rod-like liquid crystal layer and a disk-like liquid crystal layer. Alternatively, in the second aspect of the interference element of the embodiment of the present invention, the interference element may have two or more liquid crystal layer sets 54, each including a first liquid crystal layer (second liquid crystal layer) including only a disk-like liquid crystal layer and a second liquid crystal layer (first liquid crystal layer) including a rod-like liquid crystal layer and a disk-like liquid crystal layer.

Furthermore, in the second aspect of the interference element of the embodiment of the present invention, the interference element may have two or more liquid crystal layer sets, each including a first liquid crystal layer having a rod-like liquid crystal layer and a disk-like liquid crystal layer and a second liquid crystal layer having a rod-like liquid crystal layer and a disk-like liquid crystal layer, as in the above-described first aspect.

It should be noted that in any of configurations, in the second aspect of the interference element of the embodiment of the present invention, the in-plane slow axis of the first liquid crystal layer and the in-plane slow axis of the second liquid crystal layer intersect with each other, and further, the sum of the in-plane retardations of the first liquid crystal layer and the sum of the in-plane retardations of the second liquid crystal layer are equal to each other.

In addition, in the second aspect of the interference element of the embodiment of the present invention, in a case where the sum of the in-plane retardations of the first liquid crystal layer and the sum of the in-plane retardations of the second liquid crystal layer are equal to each other, the in-plane retardations of the rod-like liquid crystal layer and the disk-like liquid crystal layer may be different from each other in at least one of the first liquid crystal layer or the second liquid crystal layer.

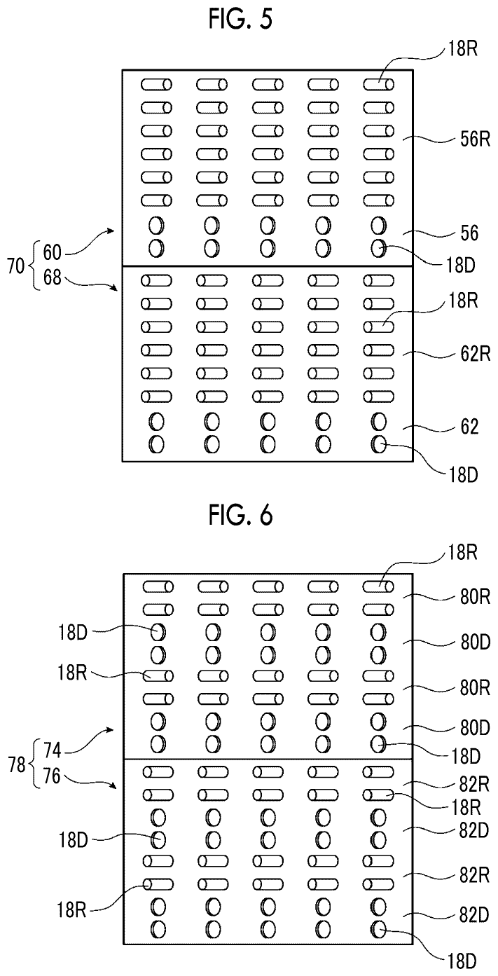

As an example, a configuration in which there are provided a plurality of liquid crystal layer sets 70, each including a first liquid crystal layer 60 having a rod-like liquid crystal layer 56R consisting of the rod-like liquid crystal compounds 18R and a disk-like liquid crystal layer 56D consisting of the disk-like liquid crystal layer compound 18D and a second liquid crystal layer 68 having a rod-like liquid crystal layer 62R consisting of the rod-like liquid crystal compounds 18R and a disk-like liquid crystal layer 62D consisting of the disk-like liquid crystal layer compound 18D, as conceptually shown in FIG. 5. In this configuration, in a case where the sums of the in-plane retardations of the first liquid crystal layer 60 and the second liquid crystal layer 68 are equal to each other, the first liquid crystal layer 60 and the second liquid crystal layer 68 may both have a larger in-plane retardation of the rod-like liquid crystal layer than the in-plane retardation of the disk-like liquid crystal layer by allowing the rod-like liquid crystal layer to be thicker than the disk-like liquid crystal layer, as shown in FIG. 5.

Alternatively, in the second aspect of the interference element of the embodiment of the present invention, in a case where both the first liquid crystal layer and the second liquid crystal layer have a rod-like liquid crystal layer and a disk-like liquid crystal layer, the in-plane retardation of the disk-like liquid crystal layer in both the first liquid crystal layer and the second liquid crystal layer may be larger than the in-plane retardation of the rod-like liquid crystal layer as long as the sums of the in-plane retardations of the first liquid crystal layers and the second liquid crystal layers are equal to each other.

Further, in the second aspect of the interference element of the embodiment of the present invention, in a case where both the first liquid crystal layer and the second liquid crystal layer have a rod-like liquid crystal layer and a disk-like liquid crystal layer, the in-plane retardation of the first liquid crystal layer (the second liquid crystal layer) may be large and the in-plane retardation of the second liquid crystal layer (the first liquid crystal layer) may be large as long as the sums of the in-plane retardations of the first liquid crystal layers and the second liquid crystal layers are equal to each other.

Such a configuration can be used even in a configuration in which any of the first liquid crystal layer and the second liquid crystal layer has only the rod-like liquid crystal layer or the disk-like liquid crystal layer as described above, as long as the sums of the in-plane retardations of the first liquid crystal layers and the second liquid crystal layers are equal to each other.

It should be noted that in any configuration, in the second aspect of the interference element of the embodiment of the present invention, the in-plane slow axis of the first liquid crystal layer and the in-plane slow axis of the second liquid crystal layer intersect with each other.

That is, in the second aspect of the interference element of the embodiment of the present invention, various configurations can be used as long as the interference element has a plurality of liquid crystal layer sets, each consisting of a first liquid crystal layer and a second liquid crystal layer,
the first liquid crystal layer and/or the second liquid crystal layer has a rod-like liquid crystal layer, and the first liquid crystal layer and/or the second liquid crystal layer has a disk-like liquid crystal layer,
an in-plane slow axis of the first liquid crystal layer and an in-plane slow axis of the second liquid crystal layer intersect with each other, and
a sum of the in-plane retardations of the first liquid crystal layer and a sum of the in-plane retardations of the second liquid crystal layer are equal to each other.

In the example above, in a case where the first liquid crystal layer and the second liquid crystal layer each have a rod-like liquid crystal layer and a disk-like liquid crystal layer, both the first liquid crystal layer and the second liquid crystal layer have one rod-like liquid crystal layer and one disk-like liquid crystal layer.

However, in the liquid crystal polarization interference element of the embodiment of the present invention, at least one of the first liquid crystal layer or the second liquid crystal layer may have a plurality of rod-like liquid crystal layers and/or a plurality of disk-like liquid crystal layers in any of the first aspect and the second aspect.

As an example, as conceptually shown in FIG. 6, a configuration may be adopted, in which there are provided two or more liquid crystal layer sets 78, each including a first liquid crystal layer 74 alternately having two alternating layers of the rod-like liquid crystal layer 80R and the disk-like liquid crystal layer 80D, and a second liquid crystal layer 76 alternately having two layers of the rod-like liquid crystal layer 82R and the disk-like liquid crystal layer 82D.

In a configuration in which at least one of the first liquid crystal layer or the second liquid crystal layer has a plurality of rod-like liquid crystal layers and disk-like liquid crystal layers, the number of at least one type of the rod-like liquid crystal layers or the disk-like liquid crystal layers may be different between the first liquid crystal layer and the second liquid crystal layer.

In addition, in the liquid crystal polarization interference element of the embodiment of the present invention, any of the first liquid crystal layer and the second liquid crystal layer may have two or more layers of at least one type of rod-like liquid crystal layers or disk-like liquid crystal layers, and the other may have one layer of each of a rod-like liquid crystal layer and one layer of a disk-like liquid crystal layer.

Alternatively, in the second aspect of the liquid crystal polarization interference element of the embodiment of the present invention, any of the first liquid crystal layer and the second liquid crystal layer may have two or more layers of at least one type of a rod-like liquid crystal layer or a disk-like liquid crystal layer, and the other may include only a rod-like liquid crystal layer or only a disk-like liquid crystal layer.

In the above-described liquid crystal polarization interference element of the embodiment of the present invention, the rod-like liquid crystal layer and the disk-like liquid crystal layer of the first liquid crystal layer and the second liquid crystal layer may include an infrared absorbing colorant.

In a case where the rod-like liquid crystal layer and the disk-like liquid crystal layer includes the infrared absorbing colorant, it is possible to make the liquid crystal wavelength dispersion in the liquid crystal layer strongly normal dispersion. As a result, it is possible to narrow the wavelength range of light on which the liquid crystal polarization interference element acts as a λ/2 wavelength plate. That is, by adding the infrared absorbing colorant to the rod-like liquid crystal layer and the disk-like liquid crystal layer and making the liquid crystal wavelength dispersion in the liquid crystal layer strongly normal dispersion, it is possible to obtain a band-pass filter having a narrower transmission wavelength range.

As the infrared absorbing colorant, various infrared absorbing colorants that can reduce a difference in refractive index between the x direction and the y direction by being aligned in the same direction as the liquid crystal compound can be used.

The infrared absorbing colorant is not particularly limited as long as it is a colorant that absorbs infrared rays (for example, light having a wavelength of 700 to 900 nm). Among these, the infrared absorbing colorant is preferably a dichroic colorant. Furthermore, the dichroic colorant refers to a colorant having a property that an absorbance in the long axis direction and an absorbance in the short axis direction in the molecule are different from each other.

As the infrared absorbing colorant, diketopyrrolopyrrole-based colorants, diimmonium-based colorants, phthalocyanine-based colorants, naphthalocyanine-based colorants, azo-based colorants, polymethine-based colorants, anthraquinone-based colorants, pyrylium-based colorants, squarylium-based colorants, triphenylmethane-based colorants, cyanine-based colorants, and aminium-based colorants.

In addition, as the infrared absorbing colorant, a metal complex colorant and a boron complex-based colorant can also be used.

The infrared absorbing colorant is described in detail in WO2019/044859A.

The amount of the infrared absorbing colorant to be added in the rod-like liquid crystal layer and the disk-like liquid crystal layer is not particularly limited, and may be appropriately set depending on the width of the transmission wavelength range required for the band-pass filter and the like.

Furthermore, in the liquid crystal polarization interference element of the embodiment of the present invention, the rod-like liquid crystal layer and the disk-like liquid crystal layer of the first liquid crystal layer and the second liquid crystal layer may include a liquid crystal elastomer.

With regard to the rod-like liquid crystal layer and the disk-like liquid crystal layer, including the liquid crystal elastomer, even in a case where the liquid crystal layer is formed using the liquid crystal elastomer, the liquid crystal layer formed of a usual liquid crystal compound that is not an elastomer may include the liquid crystal elastomer.

In this manner, by allowing the rod-like liquid crystal layer and the disk-like liquid crystal layer to include a liquid crystal elastomer, the first liquid crystal layer and the second liquid crystal layer can have elasticity, and by stretching or contracting the filter in the plane direction, it is possible to change the thickness of the liquid crystal layer.

By changing the thickness of the liquid crystal layer, the in-plane retardation of the liquid crystal layer can be changed. As a result, in the band-pass filter, it is possible to change the wavelength range of light transmitted through the filter. That is, by allowing the rod-like liquid crystal layer and the disk-like liquid crystal layer to include a liquid crystal elastomer, the wavelength range can vary by stretching and contracting the liquid crystal layer, that is, the filter, whereby it is possible to actively control the wavelength in the band-pass filter.

The liquid crystal elastomer is not limited and various known liquid crystal elastomers can be used.

As the liquid crystal elastomer, for example, a liquid crystal elastomer prepared using a liquid crystal monomer, a crosslinking agent, and a plasticizer, described in JP2020-131638A, can be used. Therefore, mechanical properties are imparted to the liquid crystal elastomer, and rubber elasticity is given, which makes deformation according to an external force that is necessary for active wavelength control possible.

Furthermore, in a case where the rod-like liquid crystal layer and the disk-like liquid crystal layer are formed of a usual liquid crystal compound that is not an elastomer, and a liquid crystal elastomer is added to impart elasticity, the amount of the liquid crystal elastomer to be added is not limited, and may be appropriately set depending on the required elasticity, that is, the control range of the transmission wavelength range.

The optical filter of the embodiment of the present invention is an optical filter in which a first polarizer, the liquid crystal polarization interference element of the embodiment of the present invention (first aspect and/or second aspect), and a second polarizer are arranged in this order.

In the optical filter (filter 10) of the embodiment of the present invention shown in FIG. 1, the first polarizer 12 and the second polarizer 14, which sandwich the liquid crystal polarization interference element of the embodiment of the present invention in the thickness direction, are arranged such that transmission axes thereof are orthogonal to each other (crossed nicols).

However, the optical filter of the embodiment of the present invention, using the liquid crystal polarization interference element of the embodiment of the present invention, is not limited thereto and various configurations can be used.

For example, in the liquid crystal polarization interference element of the embodiment of the present invention, a configuration in which the angle of the in-plane slow axis with respect to the reference line sequentially increases in the alternating lamination direction of the first liquid crystal layer and the second liquid crystal layer as in Example 30 which will be described later can also be used. In a case where such a liquid crystal polarization interference element of the embodiment of the present invention is used, the optical filter (band-pass filter) of the embodiment of the present invention may preferably have the polarizers that sandwich the liquid crystal polarization interference element of the embodiment of the present invention in the thickness direction may be arranged such that the transmission axes thereof are parallel to each other.

In a case where the optical filter of the embodiment of the present invention is used as a band-pass filter, it is preferable that the transmission axes of the first polarizer and the second polarizer are set to appropriate angles in order to preferably obtain desired band-pass characteristics.

In particular, in a case where the optical filter of the embodiment of the present invention is used as a band-pass filter, by appropriately adjusting the angles of the transmission axes of the polarizers that sandwich the liquid crystal polarization interference element of the embodiment of the present invention in the thickness direction, it is possible to perform adjustment to reduce the size of side lobes generated on both sides of the main band-pass wavelength (the long wavelength side and the short wavelength side) and to make the sizes of the side lobes on the long wavelength side and the short wavelength side uniform.

In the optical filter of the embodiment of the present invention, a retardation layer may be provided at least one of a position between the first polarizer and the liquid crystal polarization interference element or a position between the second and first polarizers and the liquid crystal polarization interference element. That is, in the optical filter of the embodiment of the present invention, a retardation layer can be provided on one side or both sides between the liquid crystal polarization interference element and the polarizer.

The retardation layer brings about an effect of maintaining the orthogonal relationship of the polarization directions by the linear polarizers arranged in a crossed nicols state not only in the front but also in an off-axis oblique direction of the polarizer. As a result, in a case where the optical filter of the embodiment of the present invention is used as a band-pass filter, good band-pass characteristics similar to those in the front can be obtained even in an oblique direction.

It is preferable that the in-plane slow axis of the retardation layer is parallel to the absorption axis of any of the first polarizer and the second polarizer arranged in a crossed nicols state. This makes it possible to compensate for the polarization state to maintain the orthogonal relationship between the polarization directions in the oblique direction without affecting the front surface.

Examples of the retardation layer include a positive C-plate formed by vertical alignment of rod-like liquid crystals and a positive A-plate formed by horizontal alignment of rod-like liquid crystals; a negative C-plate formed by disk-like liquid crystals and a negative A-plate formed by disk-like liquid crystals; or a combination thereof. In addition, a B-plate (with an Nz factor of 0.1 to 0.9) that is a biaxial refractive index body can also be used as the retardation layer.

Such a liquid crystal polarization interference element and optical filter of the embodiments of the present invention can be used at any wavelength. That is, the optical filter of the embodiment of the present invention can be used for any electromagnetic waves such as ultraviolet rays, visible light, infrared rays, terahertz waves, and millimeter waves.

The optical system of the embodiment of the present invention includes a light source section, the optical filter of the embodiment of the present invention, and a light receiving section.

In such an optical system of the embodiment of the present invention, for example, by using the optical filter of the embodiment of the present invention as a band-pass filter, it is possible to realize an optical system with a small light receiving loss.

Furthermore, in the optical system of the embodiment of the present invention, the light source unit is not limited and various known light source units (a light source, a light emitting element) capable of emitting light having a desired wavelength, such as a light emitting diode (LED), an organic electro-luminescence (OLED) element, a fluorescent lamp, a halogen lamp, a laser light source, and a plasma light source, can be used.

In addition, in the optical system of the embodiment of the present invention, the light receiving section is not limited and various known light receiving sections (a light receiving element, an imaging element) can be used as long as they can receive light having a target wavelength and can perform photometry, such as a CCD sensor, a photomultiplier, a CMOS sensor, and a photodiode.

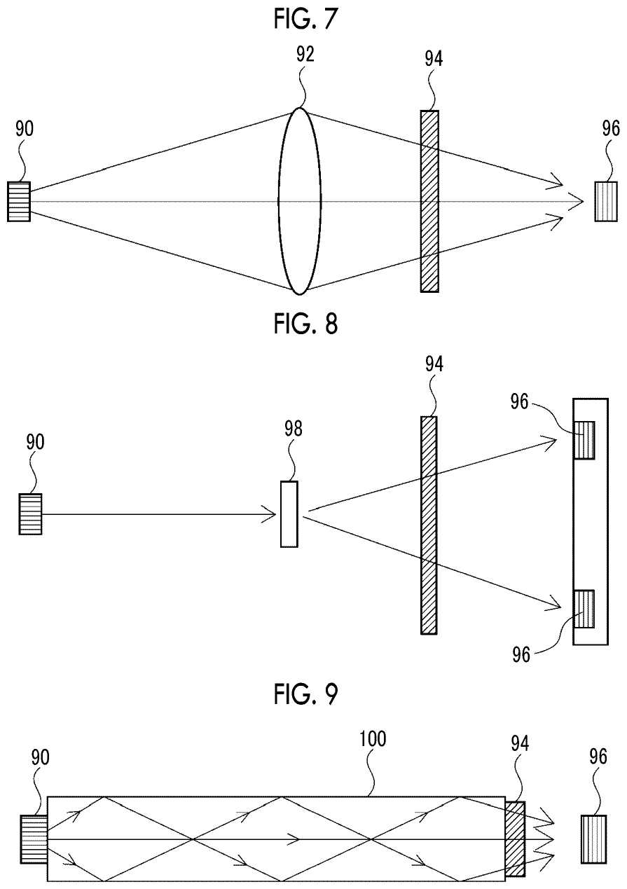

An example in which a condenser lens is combined with the optical system of the embodiment of the present invention is conceptually shown in FIG. 7.

The optical system shown in FIG. 7 has a light source unit 90, a condenser lens 92, an optical filter 94 of the embodiment of the present invention, and a light receiving section 96. Furthermore, various known condenser lenses can be used as the condenser lens.

In this optical system, the divergent light emitted from the light source unit 90 is collected by the condenser lens 92, received by the light receiving section 96, and subjected to photometry. In such an optical system, the optical filter 94 (band-pass filter) of the embodiment of the present invention is arranged in a light diverging section or a light condensing section. In the example shown in the drawing, the optical filter 94 of the embodiment of the present invention is arranged in the light condensing section.

As described above, the optical filter of the embodiment of the present invention exhibits the band-pass performance at the same wavelength for light in the front direction and light in the oblique direction, whereby light having a desired wavelength in a wide angle range can be collected in the light receiving section. The optical system of the embodiment of the present invention can thus be an optical system in which high light receiving efficiency can be obtained and a light receiving loss is thus small.

Thus, the optical system of the embodiment of the present invention using the condenser lens can be used, for example, in an imaging system. This imaging system can realize a system with high light receiving efficiency in a case where light from the light source unit 90 which is a target to be imaged is condensed by the condenser lens in various directions and is condensed by the light receiving section 96 which is an imaging element. In addition, since the optical filter of the embodiment of the present invention has band-pass performance at a wide angle, a thin and small optical system can be realized by using a condenser lens having a high numerical aperture.

Furthermore, the optical system of the embodiment of the present invention can also be used, for example, in a system using an optical fiber. In this case, the system having high efficiency in the same manner as described above can be configured, in which an out terminal of the optical fiber is provided on the light source unit 90 side and an in terminal of the optical fiber is provided on the light receiving section 96 side. Specifically, the light from the output terminal of the optical fiber and/or the light obtained by condensing the light with a lens is a mixture of lights coming at various angles. Therefore, the optical system (optical filter) of the embodiment of the present invention can be used in order to efficiently select only light having a desired wavelength at any angle and integrate the light into the sensor.

FIG. 8 conceptually shows an example in which a beam splitter is combined with the optical system of the embodiment of the present invention.

An optical system shown in FIG. 8 includes a light source unit 90, a beam splitter 98, the optical filter 94 of the embodiment of the present invention, and a light receiving section 96. Furthermore, various known beam splitters can be used as the beam splitter.

In this optical system, the light traveling straight from the light source unit 90 is branched in a plurality of (two in the drawing) different angular directions by the beam splitter 98, and the branched light is received by the light receiving sections 96 corresponding to the branched light and subjected to photometry.

In such an optical system, the optical filter 94 (band-pass filter) of the embodiment of the present invention is arranged in a region after the light is branched. The optical filter 94 of the embodiment of the present invention exhibits the same wavelength band-pass performance for branched light traveling in different angular directions with one optical filter 94. As a result, high light receiving efficiency is obtained in any of the plurality of light receiving sections 96 that receive the branched light.

The optical system of the embodiment of the present invention using the beam splitter 98 in this manner can be applied to various optical systems such as a sensor and a laser.

In addition, in a system using an optical fiber, the system of the embodiment of the present invention can be used in a case where a ray of straight light is branched at different angles by a beam splitter and then the connection destination is switched depending on the destination of the optical signal.

An example in which a light guide element (light guide plate) is combined with the optical system of the embodiment of the present invention is conceptually shown in FIG. 9.

The optical system shown in FIG. 9 has a light source unit 90, a light guide element 100, the optical filter 94 of the embodiment of the present invention, and a light receiving section 96. Furthermore, various known light guide elements can be used as the light guide element.

In this optical system, light emitted from the light source unit 90 in various angular directions is incident on an end part of the light guide element 100, and light that propagates through the light guide element 100 while being mixed is emitted from the other end part of the light guide element 100, received by the light receiving section 96, and subjected to photometry.

In such an optical system, the optical filter 94 (band-pass filter) of the embodiment of the present invention is arranged at an emission position of the light propagating from the light guide element 100. The optical filter 94 of the embodiment of the present invention exhibits the same wavelength band-pass performance for propagating light traveling in different angular directions. As a result, high light receiving efficiency can be obtained for the propagating light emitted from the light guide element.

The optical system of the embodiment of the present invention using such a light guide element can be used in a sensing system using a light guide element, a display system such as an AR, and an optical communication system using a waveguide.

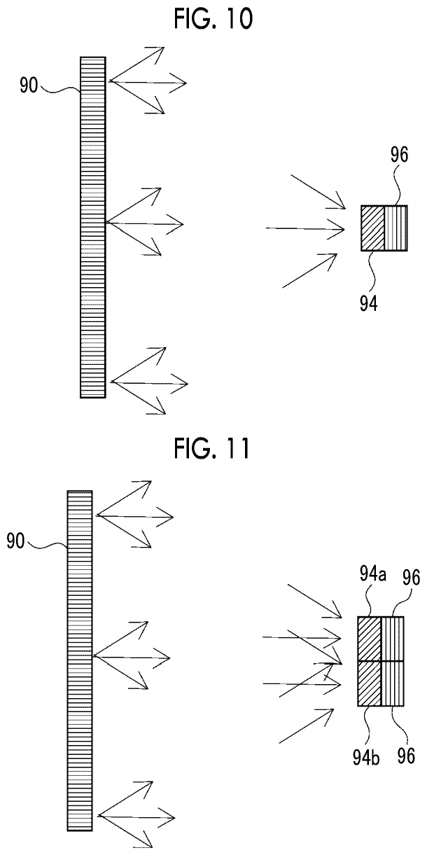

In the optical system of the embodiment of the present invention, the optical filter 94 of the embodiment of the present invention and the light receiving section 96 may be provided adjacent to each other, as conceptually shown in FIG. 10.

In the optical system shown in FIG. 10, the divergent light emitted from the light source unit 90 reaches the optical filter 94 (band-pass filter) of the embodiment of the present invention from various angular directions. Here, the optical filter 94 of the embodiment of the present invention can take in light having a desired wavelength into adjacent light receiving sections at a wide angle due to the band-pass performance at a wide angle. As a result, high light receiving efficiency is obtained in the light receiving section 96.

In an optical system in which the light source unit 90 emits divergent light, the optical filter 94 of the embodiment of the present invention exhibits desired band-pass performance at a wide angle, which is effective to make the system thinner, by using the optical system of the embodiment of the present invention, using the optical filter 94 of the embodiment of the present invention.

Furthermore, in the optical system of the embodiment of the present invention, in which the optical filter of the embodiment of the present invention and the light receiving section are adjacent to each other, a plurality of the optical filters having different central wavelengths of transmitted light may be arranged.

FIG. 11 shows an example thereof.

In the optical system shown in FIG. 11, as in the example shown in FIG. 10, the optical filter (band-pass filter) of the embodiment of the present invention can achieve high light receiving efficiency with band-pass performance at a wide angle with respect to the divergent light emitted from the light source unit 90. Here, in the example shown in FIG. 11, the optical system has the optical filter 94a and the optical filter 94b of the embodiment of the present invention, having different central wavelengths of transmitted light, and a plurality of light receiving sections 96 corresponding to the respective optical filters. In the optical system shown in FIG. 11, light having different wavelengths can be received at the same time.

Such an optical system of the embodiment of the present invention shown in FIG. 11 can be specifically used as a multispectral sensor. For example, according to the optical system of the embodiment of the present invention, it is possible to realize an optical system that senses diffused light from the skin including health information of a person at different wavelengths with high light receiving efficiency using a thin optical system.

In the example shown in FIG. 11, two optical filters having different central wavelengths of transmitted light are used, but the optical system of the embodiment of the present invention is not limited thereto. For example, according to the optical system of the embodiment of the present invention, it is possible to realize a thin and compact optical system capable of highly efficient measurements for multispectral and hyperspectral imaging, and the like by increasing the number of optical filters having different central wavelengths of transmitted light, that is, the number of wavelengths to be measured.

In addition, the optical filter of the embodiment of the present invention may also serve as an optical filter that corresponds to multi-wavelengths on a single sheet by patterning a plurality of liquid crystal polarization interference elements having different central wavelengths of transmission within the plane. In this case, patterning in which the value of the retardation varies depending on the location is performed, but this can be realized by changing any of the film thickness or the birefringence of the liquid crystal layer within the plane. The patterning may be any one of discrete patterning or continuous patterning.

Hereinbefore, the liquid crystal polarization interference element, the optical filter, and the optical system of the embodiments of the present invention have been described in detail, but the present invention is not limited to the above-described examples, and various improvements or modifications may be made within a range not departing from the scope of the present invention.

### EXAMPLES

Hereinafter, the characteristics of the present invention will be described in detail with reference to Examples. The materials, the reagents, the amounts, the amounts of materials, the proportions, the treatment details, the treatment procedures, and the like shown in Examples below can be appropriately modified within a range not departing from the spirit of the present invention. Therefore, the scope of the present invention should not be construed as being limited to specific examples shown below.

### Comparative Example 1

### (Formation of Alignment Film)

A glass substrate was prepared as a support. The following coating liquid for forming an alignment film was applied onto the support by spin coating. The support on which the coating film of the coating liquid for forming an alignment film was formed was dried for 60 seconds on a hot plate at 60° C. to form an alignment film P-1 which is a photo alignment film.

### Coating Liquid for Forming Alignment Film

| | |
|---|---|
| Material for photo alignment below | 1.00 part by mass |
| Water | 16.00 parts by mass |
| Butoxyethanol | 42.00 parts by mass |
| Propylene glycol monomethyl ether | 42.00 parts by mass |

### Material for Photo Alignment

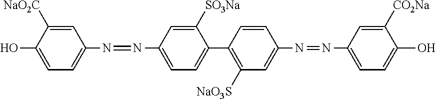

### (Exposure of Alignment Film)

Next, using an ultraviolet exposure device, the alignment film P-1 was irradiated with linearly polarized ultraviolet rays by a wire grid polarizer (ProFlux PPL02, manufactured by Moxtek, Inc.) installed such that the angle of an absorption axis was φ1 (=0°). For the ultraviolet rays, the illuminance was set to 4.5 mW/cm² and the integrated irradiation amount was set to 300 mJ/cm².

Furthermore, the angle of the absorption axis is an angle with respect to the longitudinal direction of the substrate, and counterclockwise is defined as positive.

### (Formation of Rod-Like Liquid Crystal Layer)

As the liquid crystal composition forming the rod-like liquid crystal layer, the following composition B-1 was prepared.

### Composition B-1

| | |
|---|---|
| Rod-like liquid crystal compound L-1 below | 100.00 parts by mass |
| Polymerization initiator (Irgacure (registered | 3.00 parts by mass |
| trademark) 907, manufactured by BASF SE) | |
| Photosensitizer (KAYACURE DETX-S, | 1.00 part by mass |
| manufactured by Nippon Kayaku Co., Ltd.) | |
| Leveling agent T-1 below | 0.08 parts by mass |
| Methyl ethyl ketone | 2,000.00 parts by mass |

### Rod-Like Liquid Crystal Compound L-1

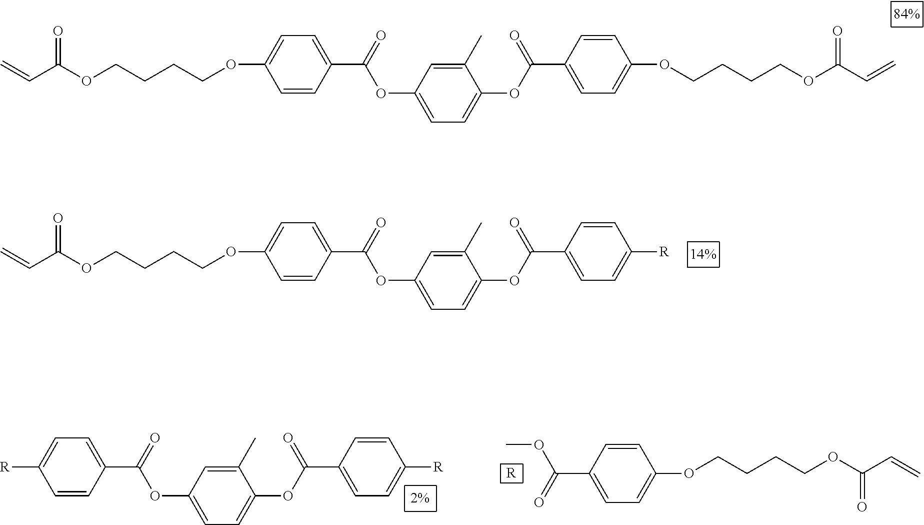

### Leveling Agent T-1

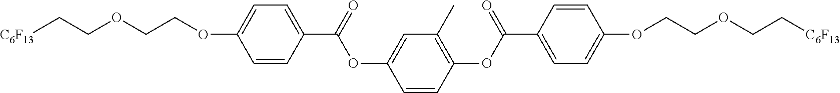

The rod-like liquid crystal layer was formed by applying the composition B-1 to the alignment film P-1.

That is, first, the composition B-1 was applied onto the alignment film P-1, heated, and then irradiated with ultraviolet rays for curing to form a rod-like liquid crystal layer as a liquid crystal immobilized layer.

More specifically, the rod-like liquid crystal layer was formed by applying the composition B-1 to the alignment film P-1 to obtain a coating film, the coating film was heated on a hot plate at 80° C., and then the coating film was irradiated with ultraviolet rays having a wavelength of 365 nm at an irradiation dose of 300 mJ/cm² using a high-pressure mercury lamp under a nitrogen atmosphere at 80° C. to immobilize the alignment of the liquid crystal compound.

The same eight rod-like liquid crystal layers were formed.

With regard to the formed eight rod-like liquid crystal layers, it was confirmed that the following optical characteristics were obtained using AxoScan (manufactured by Axometrics, Inc.).

Thickness: 1.72 μm, Δn: 0.16, in-plane retardation 275 nm

The formed rod-like liquid crystal layer was peeled off from the alignment film and bonded using a pressure sensitive adhesive (SK Dyne 2057, manufactured by Soken Chemical & Engineering Co., Ltd.) to manufacture a liquid crystal polarization interference element including the eight rod-like liquid crystal layers.

In this case, the in-plane slow axis of the rod-like liquid crystal layer of the odd-numbered layer (first liquid crystal layer) and the in-plane slow axis of the rod-like liquid crystal layer of the even-numbered layer (second liquid crystal layer) intersected with each other. Specifically, the eight rod-like liquid crystal layers were laminated and bonded such that an angle bisecting an intersection angle formed between the in-plane slow axes of the odd-numbered layer and the even-numbered layer was defined as a reference (reference line), the counterclockwise direction was defined as positive (+) and the clockwise direction was defined as negative (−), and the angle θ of the in-plane slow axis of the odd-numbered layer was 5.625° and the angle θ of the in-plane slow axis of the even-numbered layer was −5.625°. That is, the manufactured liquid crystal polarization interference element has four liquid crystal layer sets, each consisting of a first liquid crystal layer and a second liquid crystal layer.

The manufactured liquid crystal polarization interference element was arranged between the polarizers arranged in a crossed nicols state to manufacture a band-pass filter. Furthermore, the band-pass filter was manufactured by setting a line bisecting an intersection angle formed between the in-plane slow axes of the odd-numbered layer and the even-numbered layer upon lamination of the rod-like liquid crystal layers to coincide with the transmission axis of one of the polarizers.

With regard to the manufactured band-pass filter, a wavelength (central wavelength) and a half-width, at which the maximum transmittance was exhibited, a wavelength shift, and side lobes were measured using a spectroradiometer “SR-3” manufactured by Topcon Technohouse Corporation.

With regard to the wavelength shift, the wavelength shift (absolute value) was measured in a case where light was incident from a polar angle of 60° with respect to a case where light was incident from a polar angle of 90°. Furthermore, the light was incident at a polar angle of 60° from two directions, azimuth angles of 0° and 90°, and an average value was regarded as a measured value.

As a result, the manufactured band-pass filter had a central wavelength of 550 nm, a half-width of 120 nm, a wavelength shift of 90 nm, and a side lobe of 10%.

Furthermore, the size of the side lobe is a proportion of the transmittance of the side lobe to the transmittance of the central wavelength.

### Example 1

As a liquid crystal composition forming a disk-like liquid crystal layer, the following composition D-1 was prepared.

### Composition D-1

| | |
|---|---|
| Disk-like liquid crystal compound L-2 below | 80.00 parts by mass |
| Disk-like liquid crystal compound L-3 below | 20.00 parts by mass |
| Polymerization initiator (Irgacure (registered | 5.00 parts by mass |
| trade name) 907, manufactured by BASF SE) | |
| MEGAFACE F444 (manufactured by DIC | 0.50 parts by mass |
| Corporation) | |
| Methyl Ethyl Ketone | 300.00 parts by mass |

### Disk-Like Liquid Crystal Compound L-2

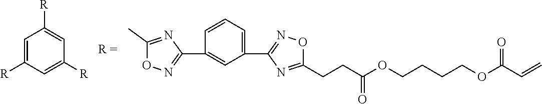

### Disk-Like Liquid Crystal Compound L-3

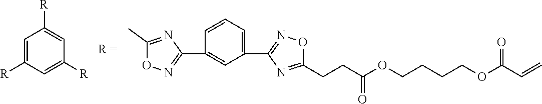

The prepared composition D-1 was applied onto the same alignment film P-1 as in Comparative Example 1, followed by heating and curing with ultraviolet rays, to form a disk-like liquid crystal layer (thickness: 0.86 μm) which is a liquid crystal immobilized layer including a disk-like liquid crystal compound.

Next, the same composition B-1 as in Comparative Example 1 was applied, followed by heating and curing with ultraviolet rays, to form a rod-like liquid crystal layer (thickness: 0.86 μm) which is a liquid crystal immobilized layer including a rod-like liquid crystal compound. This rod-like liquid crystal layer was bonded to the disk-like liquid crystal layer with a pressure sensitive adhesive (SK Dyne 2057, manufactured by Soken Chemical & Engineering Co., Ltd.) to form a liquid crystal layer configured such that the disk-like liquid crystal layer and the rod-like liquid crystal layer were laminated.

Furthermore, the temperature, heating, and hard film conditions during the formation of the disk-like liquid crystal layer and the rod-like liquid crystal layer are the same as those during the formation of the rod-like liquid crystal layer in Comparative Examples.

Eight liquid crystal layers having the same disk-like liquid crystal layers and rod-like liquid crystal layers were formed. Hereinafter, the liquid crystal layer including the disk-like liquid crystal layer and the rod-like liquid crystal layer will also be referred to as a “unit layer” for convenience.

With regard to the manufactured eight unit layers, it was confirmed that the unit layers have the following optical characteristics, using AxoScan (manufactured by Axometrics, Inc.).

### Rod-Like Liquid Crystal Layer

Thickness: 0.86 μm, Δn: 0.16, in-plane retardation 137.5 nm

### Disk-Like Liquid Crystal Layer

Thickness: 0.86 μm, Δn: 0.16, in-plane retardation 137.5 nm

The formed unit layer was peeled off from the alignment film and bonded using a pressure sensitive adhesive (SK Dyne 2057, manufactured by Soken Chemical & Engineering Co., Ltd.), and the eight layers were laminated to manufacture a liquid crystal polarization interference element.

In this case, the in-plane slow axis of the rod-like liquid crystal layer of the odd-numbered layer (first liquid crystal layer) and the in-plane slow axis of the rod-like liquid crystal layer of the even-numbered layer (second liquid crystal layer) of the laminated unit layer intersected with each other. Specifically, the eight unit layers were laminated and bonded such that an angle bisecting an intersection angle formed between both the in-plane slow axes was defined as a reference (reference line), the counterclockwise direction was defined as positive (+) and the clockwise direction was defined as negative (−), and the angle θ of the in-plane slow axis of the rod-like liquid crystal layer of the odd-numbered layer was 5.625° and the angle θ of the in-plane slow axis of the rod-like liquid crystal layer of the even-numbered layer was −5.625°. That is, the manufactured liquid crystal polarization interference element has four liquid crystal layer sets, each consisting of a first liquid crystal layer and a second liquid crystal layer.

As described above, in a case where the liquid crystal layer is formed on the liquid crystal layer by a coating method, the alignment of the liquid crystal compound in the upper liquid crystal layer follows the alignment of the liquid crystal compound in the lower liquid crystal layer.

Accordingly, in the present example,
the angle θ of the in-plane slow axis of the rod-like liquid crystal layer is:
5.625° for the odd-numbered layer and −5.625° for the even-numbered layer, and
the angle θ of the in-plane slow axis of the disk-like liquid crystal layer is:
5.625° for the odd-numbered layer and −5.625° for the even-numbered layer.

The manufactured liquid crystal polarization interference element was arranged between the polarizers arranged in a crossed nicols state to manufacture a band-pass filter. Furthermore, the band-pass filter was manufactured by setting a line bisecting an intersection angle formed between the in-plane slow axes of the odd-numbered layer and the even-numbered layer upon lamination of the laminate to coincide with the transmission axis of one of the polarizers.

For the manufactured band-pass filter, the central wavelength, the half-width, the wavelength shift, and the side lobe were measured in the same manner as in Comparative Example 1.

As a result, the manufactured band-pass filter had a central wavelength of 550 nm, a half-width of 120 nm, a wavelength shift of less than 5 nm, and a side lobe of 10%.

The wavelength shift of the band-pass filter of Comparative Example 1, in which the first liquid crystal layer and the second liquid crystal layer were formed of only the rod-like liquid crystal compound, is 90 nm. As described above, by allowing the first liquid crystal layer and the second liquid crystal layer to have the rod-like liquid crystal layer and the disk-like liquid crystal, the wavelength shift of the band-pass filter upon oblique incidence of light can be significantly suppressed.

### Example 2

In Example 1, the thickness of the unit layer and the angle of the in-plane slow axis upon lamination of the unit layers were adjusted as shown in the table below, and the eight unit layers were laminated to manufacture a liquid crystal polarization interference element. Furthermore, as described above, the unit layer is a liquid crystal layer having a rod-like liquid crystal layer and a disk-like liquid crystal layer.

That is, also in the present example, four liquid crystal layer sets, each formed from the first liquid crystal layer (odd-numbered layer) and the second liquid crystal layer (even-numbered layer), are provided.

TABLE 1

| | | | In-plane |
|---|---|---|---|
| Unit | Thickness | In-plane retardation | slow axis |
| layer | [μm] | [nm] | [°] |
| 1 | 1.82 (0.96 + 0.96) | 291 (144.5 + 144.5) | 1.8 |
| 2 | 1.82 (0.96 + 0.96) | 291 (144.5 + 144.5) | −1.8 |
| 3 | 1.67 (0.835 + 0.835) | 167 (83.5 + 83.5) | 9.4 |
| 4 | 1.67 (0.835 + 0.835) | 167 (83.5 + 83.5) | −9.4 |
| 5 | 1.67 (0.835 + 0.835) | 167 (83.5 + 83.5) | 9.4 |
| 6 | 1.67 (0.835 + 0.835) | 167 (83.5 + 83.5) | −9.4 |
| 7 | 1.82 (0.96 + 0.96) | 291 (144.5 + 144.5) | 1.8 |
| 8 | 1.82 (0.96 + 0.96) | 291 (144.5 + 144.5) | −1.8 |

For the manufactured band-pass filter, the central wavelength, the half-width, the wavelength shift, and the side lobe were measured in the same manner as in Comparative Example 1.

As a result, the manufactured band-pass filter had a central wavelength of 550 nm, a half-width of 120 nm, a wavelength shift of less than 5 nm, and a side lobe of 3% or less.

As described above, the side lobe of the band-pass filter of Example 1 is 10%. In this manner, by increasing the in-plane retardations of the liquid crystal layer sets on both sides in the thickness direction and decreasing the absolute value of the angle formed between the in-plane slow axis of the rod-like liquid crystal layer and the reference line, the side lobe of the band-pass filter can be reduced, as compared with the liquid crystal layers of the liquid crystal layer sets in the center in the thickness direction.

### Example 3

A band-pass filter was manufactured in the same manner as in Example 2, using a liquid crystal polarization interference element in which an infrared absorbing colorant was added to the rod-like liquid crystal layer and the disk-like liquid crystal layer of each unit layer in Example 2, by optical simulation for evaluating the optical performance of the laminate of a birefringent medium. For the optical simulation, “Optical Waves in Layered Media 2nd Edition, authored by Pochi Yeh, Wiley-Interscience (Mar. 3, 2005)” was used.

Furthermore, the infrared absorbing colorant was required to have dichroic absorption in the near infrared region and to be aligned as a guest colorant in a liquid crystal compound serving as a host.

Furthermore, in the present example, Δn(450)/Δn(650) in each liquid crystal layer was 1.4.

For the manufactured band-pass filter, the central wavelength, the half-width, the wavelength shift, and the side lobe were measured in the same manner as in Comparative Example 1.

As a result, the manufactured band-pass filter had a central wavelength of 550 nm, a half-width of 60 nm, a wavelength shift of less than 5 nm, and a side lobe of 3% or less.

As described above, the band-pass filter of Example 2 has a central wavelength of transmitted light of 550 nm and a half-width of 120 nm. In this manner, by adding the infrared absorbing colorant to the rod-like liquid crystal layer and the disk-like liquid crystal layer to cause strong forward dispersion, the half-width of transmitted light of band-pass filter is narrower, whereby a band-pass filter having a narrower wavelength range of transmitted light can be obtained.

### Example 4

By the same optical simulation as in Example 3, the optical performance in the same band-pass filter as in Example 2, which was manufactured using the liquid crystal elastomer as the liquid crystal compound forming the liquid crystal layer in Example 2, was obtained.

Furthermore, a condition in which as the liquid crystal elastomer, a liquid crystal elastomer prepared with a liquid crystal monomer, a crosslinking agent, and a plasticizer, described in JP2020-131638A, was used was adopted. It was possible for the liquid crystal polarization interference element of the manufactured band-pass filter to be stretched by 20%.

For the manufactured band-pass filter, the central wavelength, the half-width, the wavelength shift, and the side lobe were measured in the same manner as in Comparative Example 1.

As a result, in a state where the liquid crystal polarization interference element was not stretched, the manufactured band-pass filter had a central wavelength of 550 nm, a half-width of 60 nm, a wavelength shift of less than 5 nm, and a side lobe of 3% or less.

In this band-pass filter, by stretching the liquid crystal polarization interference element by 20%, the central wavelength of transmitted light can be controlled to 50 nm, and the central wavelength of transmitted light in a state of being stretched by 10% was 525 nm, and the central wavelength of transmitted light in a state of being stretched by 20% was 500 nm. In this manner, by allowing the rod-like liquid crystal layer and the disk-like liquid crystal layer to include the liquid crystal elastomer, the wavelength range can vary by stretching and contracting the liquid crystal polarization interference element. Thus, it is possible to actively control the wavelength control in the band-pass filter.

### Example 10

In Example 1, the number of unit layers was changed from 8 to 12, and the angle of the in-plane slow axis of the liquid crystal layer was changed as follows to form a liquid crystal polarization interference element. Furthermore, as described above, the unit layer is a liquid crystal layer having a rod-like liquid crystal layer and a disk-like liquid crystal layer.

In the present example,
the number of the unit layers is 12,
the angle θ of the in-plane slow axis of the rod-like liquid crystal layer is:
3.75° for the odd-numbered layer and −3.75° for the even-numbered layer, and
the angle θ of the in-plane slow axis of the disk-like liquid crystal layer is:
3.75° for the odd-numbered layer and −3.75° for the even-numbered layer.

That is, in the present example, six liquid crystal layer sets, each consisting of the first liquid crystal layer (odd-numbered layer) and the second liquid crystal layer (even-numbered layer), are provided.

A band-pass filter was manufactured using the liquid crystal polarization interference element in the same manner as in Example 1. In addition, for the manufactured band-pass filter, the central wavelength, the half-width, the wavelength shift, and the side lobe were measured in the same manner as in Comparative Example 1.

As a result, the manufactured band-pass filter had a central wavelength of 550 nm, a half-width of 80 nm, a wavelength shift of less than 5 nm, and a side lobe of 10%.

### Example 11

In Example 1, the odd-numbered layer (first liquid crystal layer) of the unit layer was formed of only the rod-like liquid crystal layer, the even-numbered layer (second liquid crystal layer) was formed of only the disk-like liquid crystal layer, and each of them had the following characteristics, thereby forming a liquid crystal polarization interference element. That is, in the present example, the unit layer is a liquid crystal layer set, and the liquid crystal layer set has a configuration as conceptually shown in FIG. 4.

In the present example,
the number of the unit layers is 4,
the angle θ of the in-plane slow axis of the rod-like liquid crystal layer of the odd-numbered layer (first liquid crystal layer) of the unit layer is 5.625°,
the thickness is 1.72 μm and Δn is 0.16, and
the in-plane retardation is 275 nm.

The angle θ of the in-plane slow axis of the disk-like liquid crystal layer of the odd-numbered layer (second liquid crystal layer) of the unit layer is −5.625°,
the thickness is 1.72 μm and Δn is 0.16, and
the in-plane retardation is 275 nm.

That is, also in the present example, four liquid crystal layer sets, each consisting of the first liquid crystal layer (odd-numbered layer) and the second liquid crystal layer (even-numbered layer), are provided.

A band-pass filter was manufactured using the liquid crystal polarization interference element in the same manner as in Example 1. In addition, for the manufactured band-pass filter, the central wavelength, the half-width, the wavelength shift, and the side lobe were measured in the same manner as in Comparative Example 1.

As a result, the manufactured band-pass filter had a central wavelength of 550 nm, a half-width of 120 nm, a wavelength shift of less than 10 nm, and a side lobe of 10%.

### Example 12

In Example 1, the unit layer was composed of a laminate of one rod-like liquid crystal layer and one disk-like liquid crystal layer, having the same in-plane retardation. In contrast, in the present example, the thicknesses of the rod-like liquid crystal layer and the disk-like liquid crystal layer of the unit layer were adjusted such that the in-plane retardation was as follows, and thus, a liquid crystal polarization interference element was manufactured.

### Rod-Like Liquid Crystal Layer

Thickness: 1.29 μm, Δn: 0.16, in-plane retardation 206.2 nm

### Disk-Like Liquid Crystal Layer

Thickness: 0.43 μm, Δn: 0.16, in-plane retardation 68.8 nm

That is, in the present example, the liquid crystal layer set has a configuration as conceptually shown in FIG. 5.

In addition, also in the present example, the number of unit layers is 8, and four liquid crystal layer sets, each consisting of the first liquid crystal layer (odd-numbered layer) and the second liquid crystal layer (even-numbered layer), are provided.

A band-pass filter was manufactured using the liquid crystal polarization interference element in the same manner as in Example 1. In addition, for the manufactured band-pass filter, the central wavelength, the half-width, the wavelength shift, and the side lobe were measured in the same manner as in Comparative Example 1.

As a result, the manufactured band-pass filter had a central wavelength of 550 nm, a half-width of 120 nm, a wavelength shift of less than 10 nm, and a side lobe of 10%.

### Example 13

In Example 1, both the odd-numbered layer and the even-numbered layer of the unit layers were composed of lamination of one rod-like liquid crystal layer and one disk-like liquid crystal layer. In contrast, in the present example, the configuration was changed to a configuration in which both the odd-numbered layer and the even-numbered layer of the unit layer were composed of alternate lamination of a total of four layers including two rod-like liquid crystal layers and two disk-like liquid crystal layers. That is, in the present example, the liquid crystal layer set has a configuration as conceptually shown in FIG. 6.

In addition, the characteristics of each layer are as follows.

### Rod-Like Liquid Crystal Layer

Thickness: 0.43 μm, Δn: 0.16, in-plane retardation 68.8 nm

### Disk-Like Liquid Crystal Layer

Thickness: 0.43 μm, Δn: 0.16, in-plane retardation 68.8 nm

These eight unit layers were laminated to manufacture a liquid crystal polarization interference element in the same manner as in Example 1. Accordingly, also in the present example, four liquid crystal layer sets, each consisting of the first liquid crystal layer (odd-numbered layer) and the second liquid crystal layer (even-numbered layer), are provided.

A band-pass filter was manufactured using the liquid crystal polarization interference element in the same manner as in Example 1. In addition, for the manufactured band-pass filter, the central wavelength, the half-width, the wavelength shift, and the side lobe were measured in the same manner as in Comparative Example 1.

As a result, the manufactured band-pass filter had a central wavelength of 550 nm, a half-width of 120 nm, a wavelength shift of less than 3 nm, and a side lobe of 10%.

### Example 14

In Example 1, the thicknesses of the rod-like liquid crystal layer and the disk-like liquid crystal layer in the unit layer were as follows.

### Rod-Like Liquid Crystal Layer

Thickness: 2.87 μm, Δn: 0.135, in-plane retardation 387.5 nm

### Disk-Like Liquid Crystal Layer

Thickness: 2.87 μm, Δn: 0.135, in-plane retardation 387.5 nm

Furthermore, the Δn: 0.135 of the rod-like liquid crystal layer and the Δn: 0.135 of the disk-like liquid crystal are also values at a wavelength of 1,550 nm.

The Δn: 0.15 of the rod-like liquid crystal layer and the Δn: 0.15 of the disk-like liquid crystal in Example 1 are values at a wavelength of 550 nm, and the difference from the Δn value of the present example is due to the forward dispersion characteristics of the Δn of the liquid crystal (the property that the larger the wavelength, the smaller the Δn).

Using this unit layer, a liquid crystal polarization interference element was formed in the same manner as in Example 1. That is, also in the present example, the number of unit layers is 8, and four liquid crystal layer sets, each consisting of the first liquid crystal layer (odd-numbered layer) and the second liquid crystal layer (even-numbered layer), are provided.

In addition, a band-pass filter was manufactured using the liquid crystal polarization interference element in the same manner as in Example 1.

For the manufactured band-pass filter, the central wavelength, the half-width, the wavelength shift, and the side lobe were measured in the same manner as in Comparative Example 1.

As a result, the manufactured band-pass filter had a central wavelength of 1,550 nm, a half-width of 340 nm, a wavelength shift of less than 14 nm, and a side lobe of 10%.

### Comparative Example 14

A liquid crystal polarization interference element was created using the same method as that of Example 14, except that the disk-like liquid crystal layer was changed to a rod-like liquid crystal layer.

These eight unit layers were laminated to manufacture a liquid crystal polarization interference element in the same manner as in Example 1. Accordingly, also in the present example, four liquid crystal layer sets, each consisting of the first liquid crystal layer (odd-numbered layer) and the second liquid crystal layer (even-numbered layer), are provided.

A band-pass filter was manufactured using the liquid crystal polarization interference element in the same manner as in Example 1. In addition, for the manufactured band-pass filter, the central wavelength, the half-width, the wavelength shift, and the side lobe were measured in the same manner as in Comparative Example 1.

As a result, the manufactured band-pass filter had a central wavelength of 1,550 nm, a half-width of 340 nm, a wavelength shift of less than 250 nm, and a side lobe of 10%.

From these results, it can be seen that also in Example 14 having a central wavelength (1,550 nm) different from that of Example 1, the wavelength shift is greatly improved, as compared with Comparative Example 14.

### Example 20

In Example 1, a retardation layer was arranged between the first polarizer of the polarizers arranged in a crossed nicols state and the liquid crystal polarization interference element. The retardation layer is as follows.

A positive C plate (having a thickness-direction retardation Rth of −90 nm) formed by the vertical alignment of the rod-like liquid crystals and a positive A plate (having an in-plane-direction retardation Re of 140 nm) formed by the horizontal alignment of the rod-like liquid crystals were arranged and bonded in this order adjacent to the first polarizer. In this case, the in-plane slow axis of the positive A plate was installed in parallel with the absorption axis of the polarizer on one side.

The retardation layer brings about an effect of maintaining the orthogonal relationship of the polarization directions by the linear polarizers arranged in a crossed nicols state not only in the front but also in an oblique direction.

In this manner, a band-pass filter was manufactured.

For the manufactured band-pass filter, the central wavelength, the half-width, the wavelength shift, and the side lobe were measured in the same manner as in Comparative Example 1.

As a result, the manufactured band-pass filter had a central wavelength of 550 nm, a half-width of 120 nm, a wavelength shift of less than 3 nm, and a side lobe of 10%.

### Example 30

In Example 1, a liquid crystal polarization interference element was created by arranging the eight unit layers with in-plane slow axes as shown in the following table, and a band-pass filter was created by changing the arrangement of the polarizer from a crossed nicols state (orthogonal) to a parallel nicols state (parallel).

That is, also in the present example, four liquid crystal layer sets, each formed from the first liquid crystal layer (odd-numbered layer) and the second liquid crystal layer (even-numbered layer), are provided.

The arrangement of the unit layer corresponds to a band-pass filter in which a Solc filter (Fan Solc filter) is arranged between polarizers arranged in a parallel nicols state, the Solc filter being formed by laminating a birefringent plate (a λ/2 retardation plate) having the same thickness and having angles of ρ, 3ρ, 5ρ, . . . formed between the direction of the transmission axis of the polarizer and the slow axis.

TABLE 2

| Unit layer | Angle θ (°) of in-plane slow axis |
|---|---|
| 1 | 5.625 |
| 2 | 16.875 |
| 3 | 28.125 |
| 4 | 39.375 |
| 5 | 50.625 |
| 6 | 61.875 |
| 7 | 73.125 |
| 8 | 84.375 |

For the manufactured band-pass filter, the central wavelength, the half-width, the wavelength shift, and the side lobe were measured in the same manner as in Comparative Example 1.

As a result, the manufactured band-pass filter had a central wavelength of 550 nm, a half-width of 120 nm, a wavelength shift of less than 5 nm, and a side lobe of 10%.

The optical performance of the optical system of the embodiment of the present invention, in which the optical filter of the embodiment of the present invention was used as a band-pass filter, was evaluated by optical simulation. Furthermore, the optical simulation was performed using “Lighting Simulator CAD, Camerium Inc.”.

### Example 40

An optical system having a light source unit, a condenser lens, a band-pass filter, and a light receiving section as shown in FIG. 7 was configured using the optical filter of Example 1 as the band-pass filter. For the optical system, the performance of the intensity of light passing through the system was evaluated.

The wavelength of the light emitted from the light source unit was 550 nm, the focal length of the condenser lens was 50 mm, the distance between the light source and the condenser lens was 100 mm, and the distance between the condenser lens and the light receiving section was 100 mm.

### Comparative Example 40

An optical system similar to that of Example 40 was configured using the optical filter of Comparative Example 1 as the band-pass filter, and the performance was evaluated in the same manner.

### Example 41

An optical system having a light source unit, a beam splitter, a band-pass filter, and two light receiving sections as shown in FIG. 8 was configured using the optical filter of Example 1 as the band-pass filter. For the optical system, the performance of the intensity of light passing through the system was evaluated.

The wavelength of the light emitted from the light source unit was 550 nm and the interval between the two light receiving sections was 30 mm.

### Comparative Example 41

An optical system similar to that of Example 41 was configured using the optical filter of Comparative Example 1 as the band-pass filter, and the performance was evaluated in the same manner.

### Example 42

An optical system having a light source unit, a light guide element, a band-pass filter, and a light receiving section as shown in FIG. 9 was configured using the optical filter of Example 1 as the band-pass filter. For the optical system, the performance of the intensity of light passing through the system was evaluated.

The wavelength of the light emitted from the light source unit was set to 550 nm.

### Comparative Example 42

An optical system similar to that of Example 42 was configured using the optical filter of Comparative Example 1 as the band-pass filter, and the performance was evaluated in the same manner.

### Example 43

An optical system having a light source unit, a band-pass filter, and a light receiving section, in which the band-pass filter and the light receiving section were adjacent to each other, as shown in FIG. 10, was configured using the optical filter of Example 1 as the band-pass filter. For the optical system, the performance of the intensity of light passing through the system was evaluated.

The wavelength of the light emitted from the light source unit was set to 550 nm.

### Comparative Example 43

An optical system similar to that of Example 43 was configured using the optical filter of Comparative Example 1 as the band-pass filter, and the performance was evaluated in the same manner.

### Example 44

An optical system having a light source unit, two band-pass filters of first and second band-pass filters, and two light receiving sections of first and second light receiving sections, in which the band-pass filter and the light receiving section are adjacent to each other, as shown in FIG. 11 was configured. In addition, the adjacent configurations were made to be arranged in a direction that does not overlap with the path of the light from the light source section. For the optical system, the performance of the intensity of light passing through the system was evaluated.

Furthermore, the optical filter of Example 1 (transmission central wavelength: 550 nm) was used as the first band-pass filter, and the optical filter of Example 14 (transmission central wavelength: 1,550 nm) was used as the second band-pass filter.

In addition, a light source that continuously emits light having a wavelength of 550 to 1,550 nm was used as the light source section. Further, the intensity of light having a wavelength of 550 nm was evaluated by the first light receiving section, and the intensity of light having a wavelength of 1,550 nm was evaluated by the second light receiving section.

### Comparative Example 44

An optical system similar to that of Example 44 was configured using the optical filter of Comparative Example 1 (central wavelength of transmission: 550 nm) as the first band-pass filter and the optical filter of Comparative Example 14 (central wavelength of transmission: 1,550 nm) as the second band-pass filter, and the performance was evaluated in the same manner.

As a result of the evaluation of the optical systems above, in all of Examples 40 to 44, the intensity of light passing through the optical system was 20 times or more, as compared with the results of the corresponding Comparative Examples 40 to 44.

Thus, in the case of Examples of the optical system of the embodiment of the present invention, even in a case where the angle of the rays incident on the light receiving section is large, the band-pass performance of the band-pass filter, that is, the optical filter of the embodiment of the present invention does not change. As a result, the effect of the light incident onto the light receiving section in a wide angle range is exhibited.

This demonstrated that it is possible to obtain an optical system with less light receiving loss.

From the results above, the effects of the present invention are apparent.

The optical filter of the embodiment of the present invention can be suitably used as a band-pass filter and the like in various optical devices.

### EXPLANATION OF REFERENCES

10: (optical) filter
12: first polarizer
14: second polarizer
16: liquid crystal polarization interference element
18R: rod-like liquid crystal compound
18D: disk-like liquid crystal compound
20, 50, 60, 74: first liquid crystal layer
20R1, 24R2, 56R, 62R, 80R, 82R: rod-like liquid crystal layer
20D1, 24D2, 56D, 62D, 80D, 82D: disk-like liquid crystal layer
24, 52, 68, 76: second liquid crystal layer
26, 54, 70, 78: liquid crystal layer set
90: light source unit
92: condenser lens
94, 94a, 94b: optical filter
96: light receiving section
98: beam splitter
100: light guide element

What is claimed is:

1. A liquid crystal polarization interference element comprising:
two or more liquid crystal layer sets in a thickness direction, each set consisting of a first liquid crystal layer and a second liquid crystal layer,
wherein the first liquid crystal layer includes at least one liquid crystal layer R1 formed by immobilizing horizontally aligned rod-like liquid crystal compounds, and at least one liquid crystal layer D1 formed by immobilizing vertically aligned disk-like liquid crystal compounds,
the second liquid crystal layer includes at least one liquid crystal layer R2 formed by immobilizing horizontally aligned rod-like liquid crystal compounds, and at least one liquid crystal layer D2 formed by immobilizing vertically aligned disk-like liquid crystal compounds,
an in-plane slow axis of the liquid crystal layer R1 and an in-plane slow axis of the liquid crystal layer D1 are parallel to each other,
an in-plane slow axis of the liquid crystal layer R2 and an in-plane slow axis of the liquid crystal layer D2 are parallel to each other,
the in-plane slow axis of the liquid crystal layer R1 and the in-plane slow axis of the liquid crystal layer R2 intersect with each other,
a sum of in-plane retardations of the liquid crystal layers R1 and a sum of in-plane retardations of the liquid crystal layers D1 are equal to each other, and
a sum of in-plane retardations of the liquid crystal layers R2 and a sum of in-plane retardations of the liquid crystal layers D2 are equal to each other.

2. The liquid crystal polarization interference element according to claim 1,
wherein an in-plane retardation of the first liquid crystal layer and an in-plane retardation of the second liquid crystal layer are equal to each other.

3. The liquid crystal polarization interference element according to claim 1,
wherein the in-plane slow axes of all of the liquid crystal layers R1 are parallel to each other and the in-plane slow axes of all of the liquid crystal layers R2 are parallel to each other, and
the in-plane retardations of all of the first liquid crystal layers are equal to each other and the in-plane retardations of all of the second liquid crystal layers are equal to each other.

4. The liquid crystal polarization interference element according to claim 1,
wherein an in-plane slow axis direction of the liquid crystal layer R1 of the first liquid crystal layer and an in-plane slow axis direction of the liquid crystal layer R2 of the second liquid crystal layer in the liquid crystal layer sets arranged on both sides in the thickness direction and the liquid crystal layer set arranged in a central part in the thickness direction are different from each other, and
in-plane retardations of the first liquid crystal layer in the liquid crystal layer sets arranged on both sides in the thickness direction and the liquid crystal layer set arranged in the central part in the thickness direction are different from each other.

5. The liquid crystal polarization interference element according to claim 1,
wherein the liquid crystal layer R1 and the liquid crystal layer D1 of the first liquid crystal layer and the liquid crystal layer R2 and the liquid crystal layer D2 of the second liquid crystal layer include an infrared absorbing colorant.

6. The liquid crystal polarization interference element according to claim 1,
wherein the liquid crystal layer R1 and the liquid crystal layer D1 of the first liquid crystal layer and the liquid crystal layer R2 and the liquid crystal layer D2 of the second liquid crystal layer include a liquid crystal elastomer.

7. A liquid crystal polarization interference element comprising:
two or more liquid crystal layer sets in a thickness direction, each set consisting of a first liquid crystal layer and a second liquid crystal layer,
wherein the first liquid crystal layer or the second liquid crystal layer includes at least one liquid crystal layer R including a rod-like liquid crystal compound,
the first liquid crystal layer or the second liquid crystal layer includes at least one liquid crystal layer D including a disk-like liquid crystal compound,
an in-plane slow axis of the first liquid crystal layer and an in-plane slow axis of the second liquid crystal layer intersect with each other, and
a sum of in-plane retardations of the first liquid crystal layers and a sum of in-plane retardations of the second liquid crystal layers are equal to each other.

8. The liquid crystal polarization interference element according to claim 7,
wherein the liquid crystal layer R and the liquid crystal layer D include an infrared absorbing colorant.

9. The liquid crystal polarization interference element according to claim 7,
wherein the liquid crystal layer R and the liquid crystal layer D include a liquid crystal elastomer.

10. An optical filter comprising, arranged in the following order:
a first polarizer;
the liquid crystal polarization interference element according to claim 1; and
a second polarizer.

11. The optical filter according to claim 10,
wherein the first polarizer and the second polarizer are provided to sandwich the liquid crystal polarization interference element in a thickness direction.

12. The optical filter according to claim 10,
wherein the first polarizer and the second polarizer are arranged such that transmission axes of the two polarizers are orthogonal to each other.

13. The optical filter according to claim 10,
wherein the first polarizer and the second polarizer are arranged such that transmission axes of the two polarizers are parallel to each other.

14. The optical filter according to claim 10, further comprising:
a retardation layer between at least one of the first polarizer or the second polarizer, and the liquid crystal polarization interference element,
wherein an in-plane slow axis of the retardation layer and an absorption axis of any of the first polarizer and the second polarizer are parallel to each other.

15. An optical system comprising:
a light source unit;
the optical filter according to claim 10; and
a light receiving section.

16. The optical system according to claim 15, further comprising:
a condenser lens.

17. The optical system according to claim 15, further comprising:
a beam splitter.

18. The optical system according to claim 15, further comprising:
a light guide element.

19. The optical system according to claim 15,
wherein the optical filter and the light receiving section are adjacent to each other.

20. The optical system according to claim 19, further comprising:
a plurality of the optical filters having different central wavelengths of transmitted light.
